(19) United States
(12) Patent Application Publication
(10) Pub. No.: US 2021/0260967 A1
(43) Pub. Date: Aug. 26, 2021

(54) COMPACT AIR CONDITIONER

(71) Applicant: DENSO CORPORATION, Kariya-city (JP)

(72) Inventors: Takahiro SAKAGUCHI, Kariya-city (JP); Michio NISHIKAWA, Kariya-city (JP); Shigeru KAWANO, Kariya-city (JP); Tatsuhiro SUZUKI, Kariya-city (JP)

(21) Appl. No.: 17/318,448

(22) Filed: May 12, 2021

Related U.S. Application Data
(63) Continuation of application No. PCT/JP2019/040056, filed on Oct. 10, 2019.

(30) Foreign Application Priority Data
Nov. 27, 2018 (JP) 2018-221579

(51) Int. Cl. B60H 1/32

(52) U.S. Cl. CPC B60H 1/3228

(57) ABSTRACT

A compact air conditioner includes a compressor, a condenser, a decompressor, an evaporator, a blower, an air conditioner case, and a controller. The air conditioner case defines a cool air chamber and a warm air chamber and is configured to direct a condensed water generated in the evaporator toward the warm air chamber. When an amount of the condensed water in the air conditioner case is greater than a predetermined amount, the controller is configured to execute at least one of a first control to decrease a flow rate of an air sent to the condenser by the blower or a second control to narrow an area of a front surface of the condenser, and at least one of a third control to increase a rotational speed of the compressor or a fourth control to reduce an opening degree of a valve of the decompressor.

### CROSS REFERENCE TO RELATED APPLICATIONS

The present application is a continuation application of International Patent Application No. PCT/JP2019/040056 filed on Oct. 10, 2019, which designated the U.S. and claims the benefit of priority from Japanese Patent Application No. 2018-221579 filed on Nov. 27, 2018. The entire disclosures of all of the above applications are incorporated herein by reference.

### TECHNICAL FIELD

The present disclosure relates to a compact air conditioner.

### BACKGROUND

A compact air conditioner includes an air conditioner case housing components of a refrigeration cycle. The compact air conditioner is installed under a seat of the vehicle and is used to blow out a conditioned air through a side surface of the seat for improving a comfort of a passenger.

### SUMMARY

A compact air conditioner includes a compressor, a condenser, a decompressor, an evaporator, a blower, an air conditioner case, and a controller. The compressor is configured to draw and discharge a refrigerant. The condenser is configured to condense the refrigerant discharged out of the compressor through heat exchange between the refrigerant and an air. The decompressor is configured to decompress and expand the refrigerant from the condenser. The evaporator is configured to evaporate the refrigerant from the decompressor through heat exchange between the refrigerant and an air. The refrigerant from the evaporator flows into the compressor. The blower is configured to provide an air to the condenser and the evaporator. The air conditioner case houses the compressor, the condenser, the decompressor, and the evaporator. The air conditioner case defines a cool air chamber therein through which a cool air having flowed through the evaporator flows and a warm air chamber therein through which a cool air having flowed through the condenser flows. The air conditioner is configured to direct a condensed water generated in the evaporator toward the warm air chamber. The controller is configured to execute an evaporation promoting control to promote evaporation of the condensed water by increasing a temperature of an air in the warm air chamber when an amount of the condensed water in the air conditioner case is greater than a predetermined amount.

### BRIEF DESCRIPTION OF DRAWINGS

FIG. 1 is a cross-sectional view of a compact air conditioner of a first embodiment without an upper cover, a blowing blower, and an exhaust blower.

FIG. 2 is a cross-sectional view taken along a line II-II of FIG. 1 including the blowing blower.

FIG. 3 is a cross-sectional view taken along a line III-III of FIG. 1 including the exhaust blower.

FIG. 4 is a block diagram showing a control system of the compact air conditioner of the first embodiment.

FIG. 5 is a flowchart of a control executed by a controller of the compact air conditioner of the first embodiment.

FIG. 6 is a flowchart of a control executed by a controller of a compact air conditioner of a second embodiment.

FIG. 7 is a flowchart of a control executed by a controller of a compact air conditioner of a third embodiment.

FIG. 8 is a flowchart of a control executed by a controller of a compact air conditioner of a fourth embodiment.

FIG. 9 is a flowchart of a control executed by a controller of a compact air conditioner of a fifth embodiment.

FIG. 10 is a diagram illustrating a state where shutters for a condenser of the fifth embodiment are open.

FIG. 11 is a diagram illustrating a state where the shutters for the condenser of the fifth embodiment are closed.

FIG. 12 is a flowchart of a control executed by a controller of a compact air conditioner of a sixth embodiment.

FIG. 13 is a flowchart of a control executed by a controller of a compact air conditioner of a seventh embodiment.

FIG. 14 is a flowchart of a control executed by a controller of a compact air conditioner of an eighth embodiment.

FIG. 15 is a flowchart of a control executed by a controller of a compact air conditioner of a ninth embodiment.

FIG. 16 is a cross-sectional view of a compact air conditioner of a tenth embodiment.

FIG. 17 is a flowchart of a control executed by a controller of the compact air conditioner of the tenth embodiment.

FIG. 18 is a cross-sectional view of a compact air conditioner of an eleventh embodiment.

FIG. 19 is a cross-sectional view of a compact air conditioner of a twelfth embodiment.

FIG. 20 is a cross-sectional view of a compact air conditioner of a thirteenth embodiment illustrating a state where a differential pressure valve is closed.

FIG. 21 is a cross-sectional view of the compact air conditioner corresponding to FIG. 20 illustrating a state where the differential pressure valve is open.

FIG. 22 is a flowchart of a control executed by a controller of the compact air conditioner of the thirteenth embodiment.

### DESCRIPTION OF EMBODIMENTS

To begin with, examples of relevant techniques will be described.

In recent years, a compact air conditioner mounted in a vehicle or a personal mobility (hereinafter simply referred to as a vehicle) is developing. The compact air conditioner is one in which components of a refrigeration cycle are housed in an air conditioner case. The compact air conditioner is installed under a seat of the vehicle and is used to blow out a conditioned air through a side surface of the seat for improving a comfort of a passenger. The compact air conditioner may be used together with a vehicular air conditioner arranged inside an instrument panel of the vehicle.

By the way, in general, condensed water (i.e., drain water) generated in an evaporator in the vehicular air conditioner is discharged out of the air conditioner case. Similarly, when the condensed water in the compact air conditioner is discharged out, it is considered to define a drain port under the air conditioner case, connect a drain hose to the drain port defined under the air conditioner case, and discharge the condensed water through the drain hose.

However, as described above, the compact air conditioner may be installed under the seat of the vehicle. Generally, a space under the seat of the vehicle is small, and the seat of the vehicle is configured to be movable in a front-rear direction. Therefore, if the drain port or the drain hose are provided with the air conditioner case of the compact air conditioner, a size of the compact air conditioner increases, which makes it difficult to install the compact air conditioner under the seat. In addition, it may be difficult to handle the drain hose under the seat. As described above, if the compact air conditioner is configured to discharge the condensed water out of the air conditioner case, a vehicle mountability may be deteriorated. Thus, it is preferable that the condensed water generated in the evaporator be handled in the air conditioner case.

For example, a device may be configured to handle the condensed water generated in the evaporator as follows. The condensed water generated in the evaporator is stored in a container in the device and the condensed water in the container is heated with a pipe through which a high pressure refrigerant flows. A cloth is disposed in the container to increase an area of the condensed water and promote evaporation of the condensed water.

However, since the compact air conditioner is installed under the seat of the vehicle, it is required to downsize the compact air conditioner. Thus, the space for storing the condensed water in the air conditioning case is small and the volume of water stored in the space is also low. Therefore, it is difficult to arrange the pipe through which the high-pressure refrigerant flows in the compact air conditioner to be in contact with the condensed water in a similar manner as described in the above device. Further, if the area of the condensed water is increased with the cloth as described above, a space for the cloth is required and a pressure loss of air flowing through the air conditioner case may be increased.

In the present disclosure, a compact air conditioner capable of handling condensed water generated in an evaporator in an air conditioner case is provided.

According to an aspect of the present disclosure, a compact air conditioner includes a compressor, a condenser, a decompressor, an evaporator, a blower, an air conditioner case, and a controller. The compressor is configured to draw and discharge a refrigerant. The condenser is configured to condense the refrigerant discharged out of the compressor through heat exchange between the refrigerant and an air. The decompressor is configured to decompress and expand the refrigerant from the condenser. The evaporator is configured to evaporate the refrigerant from the decompressor through heat exchange between the refrigerant and an air. The refrigerant from the evaporator flows into the compressor. The blower is configured to provide an air to the condenser and the evaporator. The air conditioner case houses the compressor, the condenser, the decompressor, and the evaporator. The air conditioner case defines a cool air chamber therein through which a cool air having flowed through the evaporator flows and a warm air chamber therein through which a cool air having flowed through the condenser flows. The air conditioner is configured to direct a condensed water generated in the evaporator toward the warm air chamber. The controller is configured to execute an evaporation promoting control to promote evaporation of the condensed water by increasing a temperature of an air in the warm air chamber when an amount of the condensed water in the air conditioner case is greater than a predetermined amount.

According to this, the air conditioner case is configured to direct the condensed water generated in the evaporator toward the warm air chamber. Thus, the condensed water directed to the warm air chamber evaporates by the warm air having flowed through the condenser. However, when the amount of the condensed water generated in the evaporator is greater than a possible amount of the condensed water to be evaporated in the warm air chamber, the amount of the condensed water in the air conditioner case increases. Thus, when the amount of the condensed water in the air conditioner case is greater than a predetermined amount, the controller is configured to execute the evaporation promoting control to promote evaporation of the condensed water by increasing the temperature of the air in the warm air chamber. As a result, a possible amount of the condensed water to be evaporated in the warm air chamber increases, so that the condensed water can be surely handled in the air conditioner case. Since this compact air conditioner does not require a high-pressure pipe and a cloth, a space in the air conditioner case for storing the condensed water can be reduced. That is, the compact air conditioner can surely handle the condensed water in the air conditioner case without increasing the size of the air conditioner case.

Whether the amount of the condensed water in the air conditioner case is greater than the predetermined amount can be determined by various methods. For example, it may be determined by calculating a difference between a generated amount of the condensed water in the evaporator and a possible amount of the condensed water to be evaporated in the warm air chamber. Alternatively, it may be determined based on signals output by a water sensor disposed in the air conditioner case. Further, the predetermined amount is determined by experiments. For example, the predetermined amount may be a range in which the condensed water does not leak from the air conditioner case, a range in which electronic devices in the air conditioner case are not exposed to water, or a range in which the condensed water does not affect a flow of a condensed water.

Embodiments of the present disclosure will now be described with reference to the drawings. Parts that are identical or equivalent to each other in the following embodiments are assigned the same reference numerals and description thereof will be omitted.

### First Embodiment

A first embodiment will be described with reference to the drawings. A compact air conditioner 1 of the present embodiment is disposed in a seat of a vehicle or a personal mobility (hereinafter simply referred to as a vehicle) and configured to blow a conditioned air through a side surface of the seat to improve a comfort of a passenger. The terms of upper, lower, left, and right in the following description are used for descriptive purposes and do not limit a position and an orientation of the compact air conditioner 1 mounted in the vehicle.

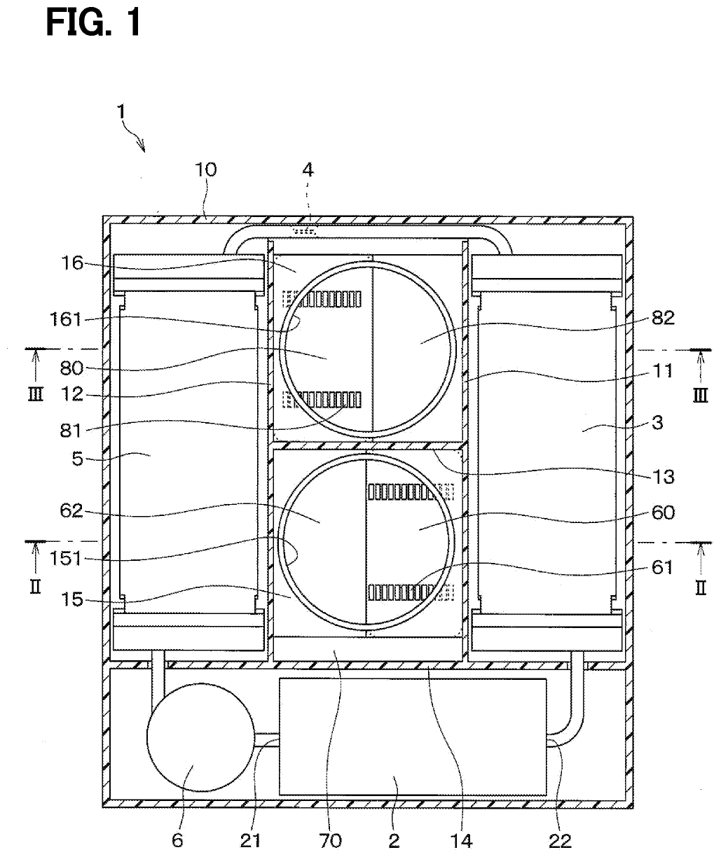

As shown in FIGS. 1 to 3, the compact air conditioner 1 has an air conditioner case 10. The air conditioner case 10 houses components of a refrigeration cycle, a blowing blower 7, and an exhaust blower 8.

The components of the refrigeration cycle includes a compressor 2, a condenser 3, a decompressor 4, an evaporator 5, and an accumulator 6. They are connected to each other with pipes and configure a vapor compression refrigerator. A refrigerant circulating through the refrigeration cycle may be a HFC refrigerant (e.g., R134a) or a HFO refrigerant (e.g., R1234yf). The refrigerant may be a natural refrigerant (e.g., carbon dioxide).

In the following descriptions, the refrigerant of the refrigeration cycle flowing from an outlet 22 of the compressor 2 to the decompressor 4 through the condenser 3 may be also referred to as a high-pressure refrigerant. Further, the refrigerant of the refrigeration cycle flowing from an outlet of the decompressor 4 to an inlet 21 of the compressor 2 through the evaporator 5 may be referred to as a low-pressure refrigerant.

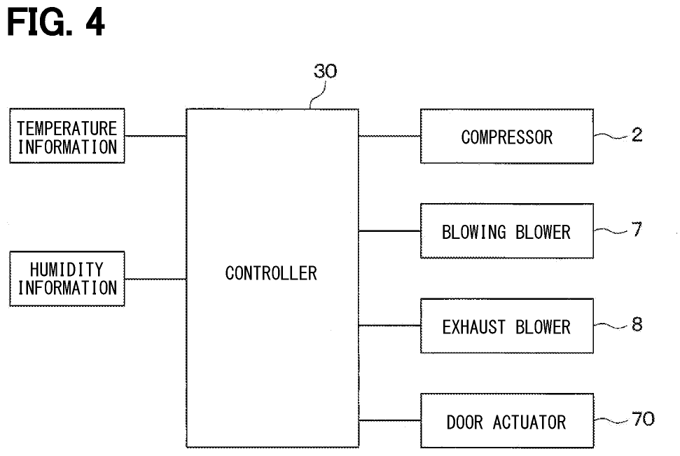

The compressor 2 is configured to draw the refrigerant through the inlet 21 and discharge the refrigerant through the outlet 22. The compressor 2 is an electric compressor that drives a compression mechanism by an electric motor. The compression mechanism may be a rotary type such as a scroll type or a vane type. The compression mechanism may be a reciprocating type such as a plunger type or a swash plate type. A rotational speed of the electric motor is controlled based on controlling signals output by a controller 30 shown in FIG. 4. Thus, the controller 30 is configured to change a refrigerant discharge capacity of the compressor 2 by controlling the rotational speed of the electric motor.

The compressor 2 is configured to discharge the high-pressure refrigerant to a pipe connected to an inlet of the condenser 3. The condenser 3 is a heat exchanger configured to exchange heat between the high-temperature high-pressure refrigerant discharged out of the compressor 2 and an air passing through the condenser 3. The refrigerant flowing through the condenser 3 dissipates heat to the air passing through the condenser 3 and condenses. The air passing through the condenser 3 absorbs heat from the refrigerant flowing through the condenser 3 to be a warm air.

The decompressor 4 is disposed in a pipe fluidly connecting between the condenser 3 and the evaporator 5. The decompressor 4 is configured to decompress and expand the refrigerant flowing from the condenser 3. The decompressor 4 may be any one of various throttle resistors including a fixed throttle such as an orifice and a capillary tube, a thermostatic expansion valve, and an electrically controlled expansion valve.

The evaporator 5 is disposed at a position downstream of the decompressor 4. The evaporator 5 is a heat exchanger configured to exchange heat between the low-temperature low-pressure refrigerant that has two phases of a liquid phase and a gas-phase, which is generated by the decompressor, and an air passing through the evaporator 5. The refrigerant flowing through the evaporator 5 absorbs heat from the air passing through the evaporator 5 and evaporates. The air passing through the evaporator 5 dissipates heat to the refrigerant flowing through the evaporator 5 to be a cool air.

The accumulator 6 is located at a position downstream of the evaporator 5. The accumulator 6 is configured to separate the gas-phase of the refrigerant flowing out of the evaporator 5 from the liquid-phase of the refrigerant, store an excess amount of the refrigerant in the refrigerant cycle, and supply the gas-phase refrigerant into the inlet 21 of the compressor 2.

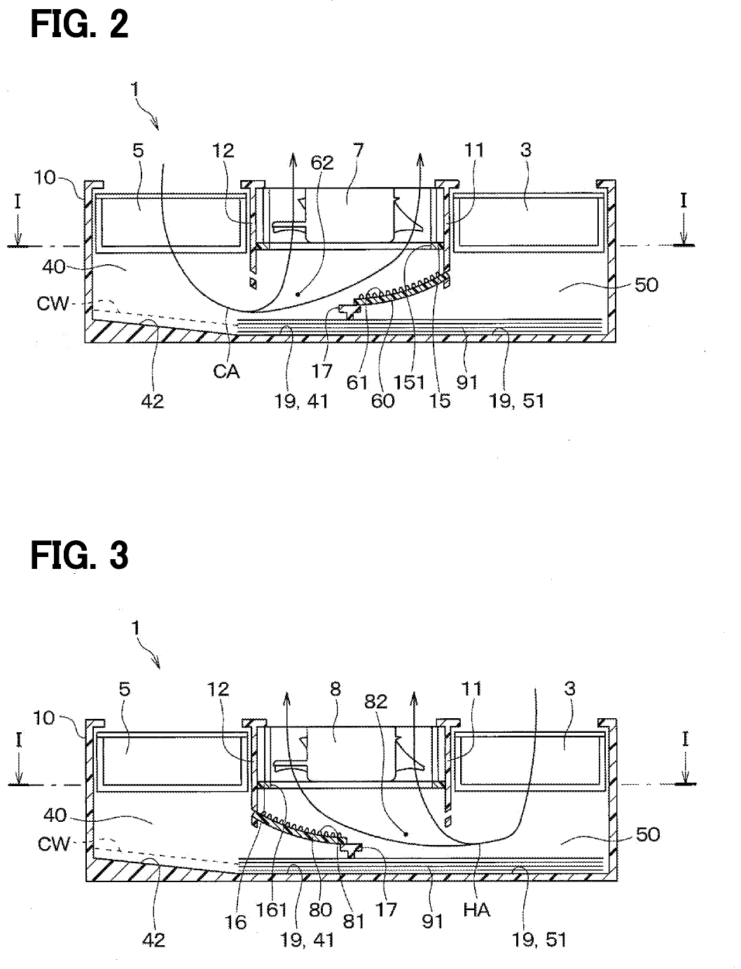

The condenser 3 is arranged in a first side portion (e.g., a right side portion in FIG. 1) of the air conditioner case 10 and the evaporator 5 is arranged in a second side portion (e.g., a left side portion in FIG. 1) in the air conditioner case 10. As shown in FIGS. 2 and 3, both the condenser 3 and the evaporator 5 are located at positions distanced from a bottom 19 of the air conditioner case 10 by a predetermined distance. That is, there is a space between the bottom 19 of the air conditioner case 10 and both of the condenser 3. There is a space between the bottom 19 of the air conditioner case 10 and the evaporator 5.

In a space between the condenser 3 and the evaporator 5, a blower configured to provide an air to the condenser 3 and the evaporator 5 is disposed. In the present embodiment, the blower includes the blowing blower 7 and the exhaust blower 8. The blowing blower 7 is configured to provide an air having passed through the condenser 3 or the evaporator 5 into the vehicle cabin that is an air-conditioning target space. The blowing blower 7 has a downstream end connected to a blowing duct (not shown). When the blowing blower 7 is operated, the cool air or the warm air generated in the air conditioner case 10 (i.e., a conditioned air) is blown out into the vehicle cabin through a side surface of the seat and the like via the blowing duct. Specifically, the cool air or the warm air is blown toward a passenger seated on the seat or toward an area near the passenger.

On the other hand, the exhaust blower 8 is configured to exhaust an air having passed through the condenser 3 or the evaporator 5. The exhaust blower 8 has a downstream end connected to an exhaust duct (not shown). When the exhaust blower 8 is operated, an exhaust air generated in the air conditioner case 10 is discharged to an area such as an outside of the vehicle through the exhaust duct not to directly reach the passenger.

Both the blowing blower 7 and the exhaust blower 8 are disposed positions downstream of the condenser 3 and the evaporator 5 in an airflow direction. That is, both the blowing blower 7 and the exhaust blower 8 are configured to draw the air having passed through the condenser 3 or the evaporator 5. Each of the blowing blower 7 and the exhaust blower 8 is configured with an impeller and an electric motor for rotating the impeller. The blowing blower 7 and the exhaust blower 8 may be any types of blower such as an axial flow type, a centrifugal type, and an once-through type. Each of a rotational speed of the blowing blower 7 and the exhaust blower 8 is controlled by control signals transmitted by the controller 30 shown in FIG. 4. Thus, the controller 30 is configured to alter a flow rate of the blowing blower 7 by controlling the rotational speed of the blowing blower 7. Further, the controller 30 is configured to alter a flow rate of the exhaust blower 8 by controlling the rotational speed of the exhaust blower 8.

The air conditioner case 10 has a substantially rectangular parallelepiped shape. The shape of the air conditioner case 10 is not limited to this, and may be any shape suitable for a space of the vehicle in which the air conditioner case 10 is mounted. The air conditioner case 10 houses the components of the refrigeration cycle including the compressor 2, the condenser 3, the decompressor 4, the evaporator 5, and the accumulator 6, the blowing blower 7, and the exhaust blower 8. The air conditioner case 10 has walls for partitioning the compressor 2, the condenser 3, the evaporator 5, the blowing blower 7, and the exhaust blower 8.

In the following descriptions, the wall provided between the blowers 7, 8 and the condenser 3 is referred to as a first wall 11. The wall provided between the blowers 7, 8 and the evaporator 5 is referred to as a second wall 12. The wall provided between the blowing blower 7 and the exhaust blower 8 is referred to as a third wall 13. The first wall 11, the second wall 12, and the third wall 13 are all distanced away from the bottom 19 of the air conditioner case 10 by a predetermined distance. That is, a space is defined between the bottom 19 of the air conditioner case 10 and the first wall 11, the second wall 12, and the third wall 13.

Further, the wall provided between the compressor 2 and the accumulator 6, and the condenser 3, the blowing blower 7, and the evaporator 5 is referred to as a fourth wall 14. The fourth wall 14 is connected to the bottom 19 of the air conditioner case 10.

The wall that is provided at a portion of the blowing blower 7 through which an air is drawn into the blowing blower 7 (i.e., a portion of the blowing blower 7 facing the bottom 19 of the air conditioner case 10) is referred to as a fifth wall 15. The fifth wall 15 is parallel to the bottom 19 of the air conditioner case 10. The fifth wall 15 defines a hole 151 corresponding to an outer diameter of the impeller of the blowing blower 7.

The wall that is provided at a portion of the exhaust blower 8 through which an air is drawn into the exhaust blower 8 (i.e., a portion of the exhaust blower 8 facing the bottom 19 of the air conditioner case 10) is referred to as a sixth wall 16. The sixth wall 16 is parallel to the bottom 19 of the air conditioner case 10. The sixth wall 16 defines a hole 161 corresponding to an outer diameter of the impeller of the exhaust blower 8. The blowing blower 7 and the fifth wall 15 may be integrally formed with each other and the exhaust blower 8 and the sixth wall 16 may be integrally formed with each other.

A partition wall 17 and a wick 91 are provided between the blowers 7, 8, and the bottom 19 of the air conditioner case 10. The partition wall 17 is connected to a lower portion of the third wall 13 and extends in a direction in which the blowing blower 7 and the exhaust blower 8 are aligned. Further, the partition wall 17, the first wall 11, and the second wall 12 are substantially parallel to each other. The partition wall 17 partitions off a space through which the cool air having passed through the evaporator 5 flows (hereinafter referred to as a cool air chamber 40) from a space through which a warm air having passed through the condenser 3 flows (hereinafter referred to as a warm air chamber 50).

A blowing door 60 is located between the bottom 19 of the air conditioner case 10 and the blowing blower 7. The blowing door 60 can cover an approximately half area of a space below the blowing blower 7. In FIGS. 1 and 2, the blowing door 60 covers an approximately half area of the space below the blowing blower 7 that is closer to the condenser 3 and opens an approximately half area of the space below the blowing blower 7 that is closer to the evaporator 5. The blowing door 60 is operated by a door actuator 70 shown in FIG. 4 and configured to reciprocally move between the first wall 11 and the second wall 12 through the partition wall 17. Specifically, the blowing door 60 has a rack 61 on a surface of the blowing door 60 facing the blowing blower 7. The rack 61 is configured to mesh with a pinion (not shown). The door actuator 70 moves the blowing door 60 by rotating the pinion.

An exhaust door 80 is located between the bottom 19 of the air conditioner case 10 and the exhaust blower 8. The exhaust door 80 can cover an approximately half area of a space below the exhaust blower 8. In FIGS. 1 and 3, the exhaust door 80 closes an approximately half area of the space below the exhaust blower 8 that is closer to the evaporator 5 and opens an approximately half area of the space below the exhaust blower 8 that is closer to the condenser 3. The exhaust door 80 is also operated by the door actuator 70 and configured to reciprocally move between the first wall 11 and the second wall 12 through the partition wall 17. Specifically, the exhaust door 80 has a rack 81 at a surface of the exhaust door 80 facing the exhaust blower 8. The rack 81 is configured to mesh with a pinion (not shown). The door actuator 70 is configured to move the exhaust door 80 by rotating the pinion.

The cool air chamber 40 of the air conditioner case 10 is defined by a lower surface of the evaporator 5, an inner surface of the air conditioner case 10, the exhaust door 80, and the partition wall 17. The cool air having passed through the evaporator 5 flows through the cool air chamber 40. On the other hand, the warm air chamber 50 in the air conditioner case 10 is defined by a lower surface of the condenser 3, the inner surface of the air conditioner case 10, the blowing door 60, and the partition wall 17. The warm air having passed through the condenser 3 flows through the warm air chamber 50. That is, the air conditioner case 10 defines therein the cool air chamber 40 and the warm air chamber 50.

The wick 91 is located between the partition wall 17 and the bottom 19 of the air conditioner case 10 as a water directing unit. The wick 91 may be a bundle of metal wires, or may be formed by metal having thin tubes. The cool air chamber 40 has a bottom 41 and the warm air chamber 50 has a bottom 51. The wick 91 extends from the bottom 51 of the warm air chamber 50 to the bottom 41 of the cool air chamber 40. The wick 91 is configured to discharge condensed water generated in the evaporator 5 from the cool air chamber 40 to the warm air chamber 50 by utilizing a surface tension and a capillary action. That is, the air conditioner case 10 of the present embodiment is configured to direct the condensed water generated in the evaporator 5 to the warm air chamber 50. Further, the wick 91 is configured to block an airflow between the cool air chamber 40 and the warm air chamber 50. The partition wall 17 for partitioning off the cool air chamber 40 from the warm air chamber 50 is located at an upper portion of the wick 91.

The wick 91 has a first portion located in the cool air chamber 40 and a second portion located in the warm air chamber 50. The second portion has an area that is larger than an area of the first portion. The area of the first portion located in the cool air chamber 40 is reduced so as to decrease an amount of water stored in the cool air chamber 40, discharge the water to the warm air chamber 50 as soon as possible at an early stage, and reduce an amount of water stored in the air conditioner case 10 when the air conditioner is stopped. The area of the second portion located in the warm air chamber 50 is increased so as to increase an area for evaporating the water and secure a total amount of the water that can be stored in the air conditioner case 10. Thus, the second portion of the wick 91 located in the warm air chamber 50 has an area larger than that of the first portion of the wick 91 located in the cool air chamber 40. Therefore, the condensed water can be reliably handled in the air conditioner case 10.

Further, the air conditioner case 10 has a tilted surface 42 at the bottom 41 of the cool air chamber 40. A height in a vertical direction of the tilted surface 42 gradually becomes higher in a direction away from the water directing unit. As a result, the condensed water at the bottom 41 of the cool air chamber 40 flows to the wick 91 by the tilted surface 42. The condensed water flowing to the wick 91 is directed from the cool air chamber 40 to the warm air chamber 50 by the wick 91 and is evaporated by the warm air flowing through the warm air chamber 50. Thus, the compact air conditioner 1 can restrict the condensed water from leaking from the air conditioner case 10 by reliably handling the condensed water in the air conditioner case 10.

Operations of the compressor 2, the blowing blower 7, the exhaust blower 8, and the door actuator 70 of the compact air conditioner 1 are controlled by the controller 30 shown in FIG. 4. The controller 30 includes a microcontroller having a processor for performing control processing and arithmetic processing, and a storage unit, such as a ROM and a RAM, for storing programs and data. The controller 30 also includes peripheral circuits for these components. The storage of the controller 30 is a non-transitional tangible storage medium. Based on programs stored in the storage unit, the controller 30 performs various types of control processing and arithmetic processing to control the operation of devices connected to output ports of the controller 30. The controller 30 may be disposed inside the air conditioner case 10 or may be disposed away from the air conditioner case 10.

In the above-described configuration, in FIGS. 1 to 3, a state where the compact air conditioner 1 operates an air-cooling in the vehicle cabin is illustrated.

When the compact air conditioner 1 operates the air-cooling in the vehicle cabin, the controller 30 operates the door actuator 70 such that the blowing door 60 closes a half area of the space below the blowing blower 7 near the condenser 3 and opens another half area of the space below the blowing blower 7 near the evaporator 5. Further, the controller 30 operates the door actuator 70 such that the exhaust door 80 closes a half area of the space below the exhaust blower 8 near the evaporator 5 and opens another half are of the space below the condenser 3 near the condenser 3. Then, the controller 30 operates the compressor 2 of the refrigeration cycle, the blowing blower 7, and the exhaust blower 8. In this case, as shown by arrows CA in FIG. 2, the cool air having passed through the evaporator 5 is drawn into the blowing blower 7 through an opening 62 defined by the blowing blower 60 and blown out toward the passenger seated on the seat or an area near the passenger through the blowing duct (not shown). At the same time, as shown by arrows HA in FIG. 3, the warm air having passed through the condenser 3 is drawn into the exhaust blower 8 through an opening 82 defined by the exhaust door 80 and discharged to an area such as an outside of the vehicle cabin through the exhaust duct (not shown) not to directly reach the passenger.

When the refrigeration cycle is operated, water vapor in the air having passed through the evaporator 5 may be condensed to be the condensed water. As shown by a broken line CW in FIGS. 2 and 3, the condensed water generated in the evaporator 5 is collected at the bottom 41 of the cool air chamber 40. As described above, the condensed water collected in the cool air chamber 40 is directed to the warm air chamber 50 through the wick 91 due to surface tension and capillary action. That is, the wick 91 serves as the water directing unit configured to direct the condensed water generated in the evaporator 5 from the cool air chamber 40 to the warm air chamber 50. The condensed water sent from the cool air chamber 40 to the warm air chamber 50 is evaporated in the warm air chamber 50 by the warm air having passed through the condenser 3. The water vapor evaporated from the condensed water is drawn into the exhaust blower 8 and discharged out of the vehicle cabin and the like through the exhaust duct (not shown) not to directly reach the passenger.

When the compact air conditioner 1 operates an air-heating in the vehicle cabin, each of the blowing door 60 and the exhaust door 80 is moved to a side opposite to the side shown in FIGS. 1 to 3 in a right-left direction. Although illustrations of a state where the compact air conditioner 1 operates the air-heating are omitted, the controller 30 operates the door actuator 70 such that the blowing door 60 closes a half area of the space below the blowing blower 7 near the evaporator 5 and opens another half area of the space below the blowing blower 7 near the condenser 3. Further, the controller 30 operates the door actuator 70 such that the exhaust door 80 closes a half area of the space below the exhaust blower 8 near the condenser 3 and opens another half area of the space below the exhaust blower 8 near the evaporator 5. Then, the controller 30 operates the compressor 2 of the refrigeration cycle, the blowing blower 7, and the exhaust blower 8. In this case, the warm air having passed through the condenser 3 is drawn into the blowing blower 7 through an opening defined by the blowing door 60 and blown into the vehicle cabin through the blowing duct (not shown). Specifically, the warm air is blown toward the passenger seated on the seat or toward an area near the passenger. At that time, the cool air having passed through the evaporator 5 is drawn into the exhaust blower 8 through an opening defined by the exhaust door 80 and discharged to an area such as the outside of the vehicle cabin through the exhaust duct (not shown) not to directly reach the passenger.

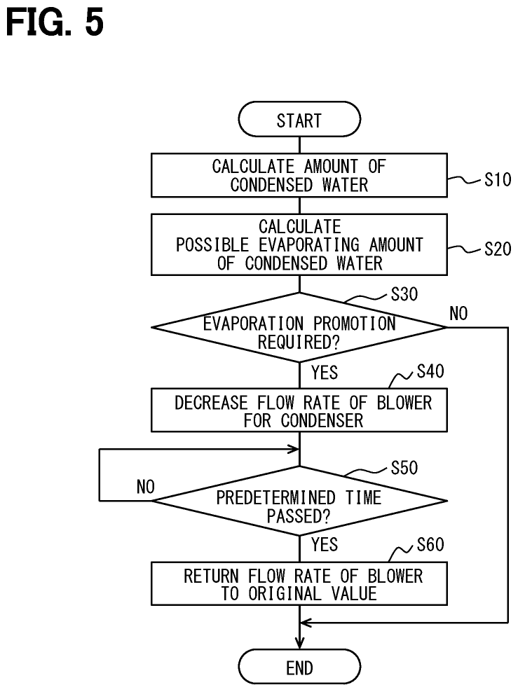

Next, a process executed by the controller 30 of the first embodiment will be described with reference to the flowchart of FIG. 5. In this description, the compact air conditioner 1 performs the air-cooling in the vehicle cabin.

First, in step S10, the controller 30 is configured to calculate an amount of the condensed water generated in the evaporator 5. The generated amount of the condensed water is calculated based on the temperature, the humidity, and the flow rate of air passing through the evaporator 5 and the temperature of the evaporator 5. The temperature and the humidity of the air passing through the evaporator 5 can be detected by a temperature sensor and a humidity sensor that are disposed in the vehicle. Alternatively, the temperature and the humidity of the air passing through the evaporator 5 may be estimated based on information on the temperature and the humidity of air outside of the vehicle that is obtained by a server or a cloud outside of the vehicle and based on an operating state of the vehicular air conditioner inside of the instrument panel. The flow rate of the air passing through the evaporator 5 can be calculated from, for example, a duty ratio of energization to the blowing blower 7 during the air-cooling. The temperature of the evaporator 5 may be detected by a temperature sensor disposed in the evaporator 5 or calculated by a capacity of the refrigeration cycle such as a rotational speed of the compressor 2.

Next, in step S20, the controller 30 is configured to calculate a possible amount of the condensed water to be evaporated in the warm air chamber 50. The possible amount of the condensed water to be evaporated is calculated, for example, by the temperature, the humidity, and the flow rate of the air flowing through the warm air chamber 50. The temperature of the air flowing through the warm air chamber 50 can be calculated from, for example, the temperature of the condenser 3 and a flow rate of the air passing through the condenser 3. The temperature of the condenser 3 may be detected, for example, by a temperature sensor disposed in the condenser 3 or calculated by the capacity of the refrigeration cycle such as the rotational speed of the compressor 2. The amount of air passing through the condenser 3 and the flow rate of the air in the warm air chamber 50 can be calculated by a duty ratio of energization to the exhaust blower 8 during the air-cooling.

Subsequently, in step S30, the controller 30 determines whether an evaporation promoting control for the condensed water is required based on the amount of the condensed water generated in the evaporator 5 that is calculated in step S10 and the possible amount of the condensed water to be evaporate in the warm air chamber 50 that is calculated in step S20. At that time, the controller 30 is configured to determine whether the evaporation promoting control for the condensed water is required by determining whether the condensed water collected in the air conditioner case 10 is greater than a predetermined amount. The amount of the condensed water collected in the air conditioner case 10 can be calculated from a difference between the amount of the condensed water generated in the evaporator 5 and the possible amount of the condensed water to be evaporated in the warm air chamber 50. Then, the controller 30 is configured to determine that the evaporation promoting control for the condensed water is required when the condensed water collected in the air conditioner case 10 is greater than the predetermined amount. The predetermined amount is appropriately determined by experiments within a range in which the condensed water does not leak from the air conditioner case 10, a range in which electronic devices in the air conditioner case 10 are not exposed to the water, or a range in which the condensed water does not affect the conditioned air.

Alternatively, as another method, when a water sensor is disposed in the air conditioner case 10, the amount of the condensed water in the air conditioner case 10 may be detected based on signals output to the controller 30 by the water sensor.

When the controller 30 determines in step S30 that it is not necessary to execute the evaporation promoting control, the process is ended for a moment. Then, after a predetermined time has elapsed, the process from step S10 is executed again.

On the other hand, when the controller 30 determines in step S30 that it is necessary to execute the evaporation promoting control for the condensed water in the air conditioner case 10, the process is advanced to step S40.

In step S40, the controller 30 is configured to execute the evaporation promoting control to increase a rate of evaporation of the condensed water. During the evaporation promoting control, a pressure of the high-pressure refrigerant circulating through the refrigeration cycle is increased. Specifically, during the evaporation promoting control in the first embodiment, the controller 30 is configured to decrease a flow rate of the blower that provides an air to the condenser 3 (hereinafter referred to as a blower for the condenser 3). That is, during the air-cooling, the controller 30 is configured to decrease a flow rate of the exhaust blower 8 that is the blower for the condenser 3.

When the controller 30 decreases the flow rate of the air passing through the condenser 3, a heat dissipation capacity of the air passing through the condenser 3 is decreased. As a result, the pressure of the high-pressure refrigerant flowing through the condenser 3 is increased to balance a capacity of the refrigerant and the capacity of the air passing through the condenser 3. Thus, the temperature of the high-pressure refrigerant flowing through the condenser 3 is increased. Therefore, the amount of heat of the high-pressure refrigerant flowing through the condenser 3 that is absorbed by the air flowing through the condenser 3 is increased, so that the temperature of the warm air that passes through the condenser 3 and then flows through the warm air chamber 50 is increased. Therefore, the controller 30 can increase the rate of evaporation of the condensed water by decreasing a flow rate of the air sent to the condenser 3 by the blower and increasing the temperature of the air flowing through the warm air chamber 50. Then, the controller 30 advances the process to step S50.

Next, in step S50, the controller 30 determines whether the predetermined period has passed since the evaporation promoting control was started. The predetermined period is set to a period required for evaporating the condensed water stored in the air conditioner case 10. The controller 30 advances the process to step S60 when the controller 30 determines in step S50 that the predetermined period has elapsed.

In step S60, the controller 30 is configured to return the flow rate of the blower for the condenser 3 to an original flow rate. Then, the controller 30 ends the process for a moment and after a predetermined time has passed, the process from step S10 is repeated.

The compact air conditioner 1 of the first embodiment described above has the following advantages.

(1) In the first embodiment, the controller 30 is configured to execute the evaporation promoting control to increase a rate of evaporation of the condensed water when the amount of the condensed water in the air conditioner case 10 is greater than the predetermined amount. The evaporation promoting control is executed by increasing the pressure of the high-pressure refrigerant circulating through the refrigeration cycle. As the pressure of the high-pressure refrigerant increases, the temperature of the high-pressure refrigerant flowing through the condenser 3 increases. Therefore, the amount of heat of the high-pressure refrigerant flowing through the condenser 3 that is absorbed by the air flowing through the condenser 3 increases, so that the temperature of the warm air that passes through the condenser 3 and then flows through the warm air chamber 50 increases. As a result, the rate of evaporation of the condensed water in the warm air chamber 50 is increased and the condensed water can be reliably handled in the air conditioner case 10. Since the compact air conditioner 1 does not require the high-pressure pipe and cloth in a space of the air conditioner case 10 for storing the condensed water, the space of the air conditioner case 10 for storing the condensed water can be reduced. Thus, the compact air conditioner 1 can reliably handle the condensed water in the air conditioner case 10 and restrict the condensed water from leaking from the air conditioner case 10 without increasing the size of the air conditioner case 10.

(2) In the first embodiment, the controller 30 is configured to decrease a flow rate of the blower for the condenser 3 during the evaporation promoting control. As a result, the pressure of the high-pressure refrigerant flowing through the condenser 3 is increased and the temperature of the high-pressure refrigerant is increased, so that the temperature of the air flowing through the warm air chamber 50 is increased. Therefore, the compact air conditioner 1 can reliably handle the condensed water in the air conditioner case 10 and restrict the condensed water from leaking from the air conditioner case 10.

(3) In the first embodiment, the wick 91 as the water directing unit is disposed to extend from the bottom 41 of the cool air chamber 40 to the bottom 51 of the warm air chamber 50. As a result, the condensed water generated in the evaporator 5 is constantly sent from the cool air chamber 40 to the warm air chamber 50 by the wick 91, and is evaporated by the warm air flowing through the warm air chamber 50. The wick 91 does not require a mechanical mechanism because the wick 91 uses capillary force, so that a size of the wick 91 itself can be decreased. Therefore, a space in the air conditioner case 10 for disposing the wick 91 can be reduced and the wick 91 is restricted from interfering with other components of the compact air conditioner 1. Therefore, the compact air conditioner 1 can improve a mountability in the vehicle without increasing the size of the compact air conditioner 1.

### Second Embodiment

A second embodiment will be described. The second embodiment is different from the first embodiment in a specific method of the evaporation promoting control executed by the controller 30. The other portions are the same as those of the first embodiment and only portions different from the first embodiment will be described.

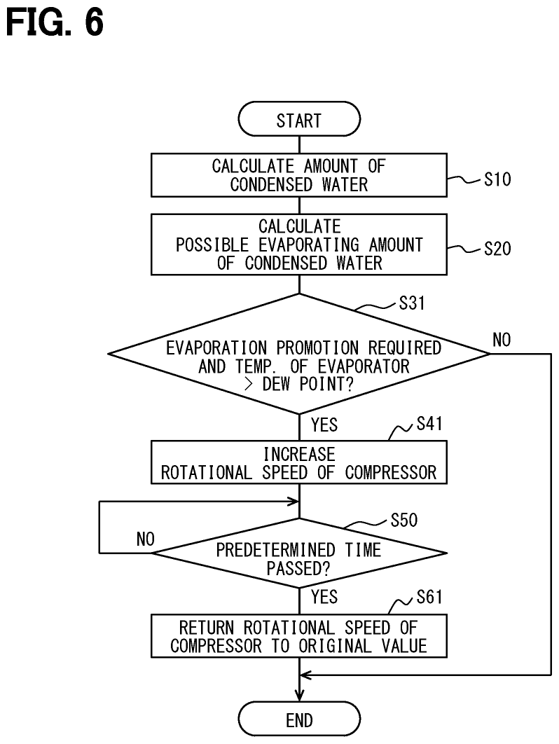

The process executed by the controller 30 of the second embodiment will be described with reference to the flowchart of FIG. 6.

The processes of steps S10 and S20 are the same as the processes described in the first embodiment.

In step S31, the controller 30 determines whether evaporation promotion of the condensed water generated in the evaporator 5 is required based on the generated amount of the condensed water that is calculated in step S10 and the possible amount of the condensed water to be evaporated in the warm air chamber 50 that is calculated in step S20, similarly to the first embodiment. As with the first embodiment, the controller 30 is configured to determine whether the evaporation promotion of the condensed water is required by determining whether the amount of the condensed water stored in the air conditioner case 10 is greater than the predetermined amount.

Further, in step S31, the controller 30 further determines whether the temperature of the evaporator 5 is higher than the dew point of the air passing through the evaporator 5. This is because when the rotational speed of the compressor 2 is increased in the following step S41 which will be described later, the temperature of the evaporator 5 is decreased and the amount of the condensed water may be increased.

When the controller 30 determines that the amount of the condensed water stored in the air conditioner case 10 is less than the amount of the predetermined amount or that the temperature of the evaporator 5 is lower than the dew point of the air passing through the evaporator 5, the process is ended for a moment. After a predetermined time has passed, the process from step S10 is performed again.

On the other hand, when the controller 30 determines in step S31 that the amount of water stored in the air conditioner case 10 is greater than the predetermined amount and the temperature of the evaporator 5 is higher than the dew point of the air passing through the evaporator 5, the process is advanced to step S41.

In step S41, the controller 30 executes the evaporation promoting control to increase the rate of evaporation of the condensed water. Specifically, in the second embodiment, the controller 30 is configured to increase the rotational speed of the compressor 2 as the evaporation promoting control.

When the controller 30 increases the rotational speed of the compressor 2, a flow rate of the refrigerant is increased. As a result, the capacity of the refrigerant is increased, thereby the pressure of the low-pressure refrigerant is decreased to secure the heat absorption capacity of the evaporator 5. Then, the pressure of the high-pressure refrigerant is increased to secure the heat dissipation capacity of the condenser 3 to balance the heat absorption capacity of the evaporator 5 and the heat dissipation capacity of the condenser 3. Thus, the temperature of the high-pressure refrigerant flowing through the condenser 3 is increased and the amount of air absorbed by the air passing through the condenser 3 from the high-pressure refrigerant flowing through the condenser 3 is increased. As a result, the temperature of the warm air flowing through the warm air chamber 50 is increased. Therefore, the controller 30 can increase the rate of evaporation of the condensed water by increasing the rotational speed of the compressor 2 during the evaporation promoting control. Then, the controller 30 advances the process to step S50.

The process of step S50 is substantially the same as the process described in the first embodiment. In step S50, the controller 30 is configured to advance the process to step S61 when the predetermined period has elapsed.

In step S61, the controller 30 is configured to return the rotational speed of the compressor 2 to the original speed. Then, the controller 30 is configured to end the process for a moment and start the process from the step S10 again after a predetermined time has passed.

In the second embodiment described above, the controller 30 is configured to increase the rotational speed of the compressor 2 as the evaporation promoting control. As a result, the second embodiment can also achieve the same advantages as those of the first embodiment.

### Third Embodiment

A third embodiment will be described. The third embodiment is also different from the first embodiment in a specific method of the evaporation promoting control executed by the controller 30. Other portions are the same as those of the first embodiment and only other portions different from those of the first embodiment will be described.

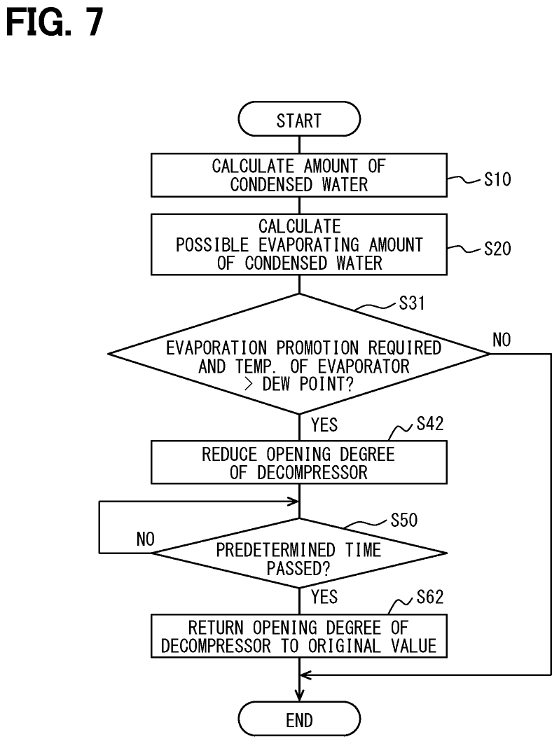

The control executed by the controller 30 of the third embodiment will be described with reference to the flowchart of FIG. 7.

The processes of steps S10 to S31 are the same as the processes described in the second embodiment.

When the controller 30 determines in step S31 that the amount of the condensed water stored in the air conditioner case 10 is greater than the predetermined amount and that the temperature of the evaporator 5 is higher than the dew point of the air passing through the evaporator 5, the process is advanced to step S42.

In step S42, the controller 30 executes evaporation promoting control to increase the rate of evaporation of the condensed water. Specifically, in the third embodiment, the controller 30 is configured to reduce an opening degree of a valve of the decompressor 4 (i.e., to reduce a passage area) as the evaporation promoting control. In the third embodiment, the decompressor 4 is an electrically controlled expansion valve.

When the controller 30 reduces the opening degree of the valve of the decompressor 4, the pressure of the low-pressure refrigerant is decreased and the pressure of the high-pressure refrigerant is increased by a reduced opening degree of the decompressor 4. Thus, the temperature of the high-pressure refrigerant flowing through the condenser 3 is increased and the amount of air absorbed by the air passing through the condenser 3 from the high-pressure refrigerant flowing through the condenser 3 is increased. As a result, the temperature of the warm air flowing through the warm air chamber 50 is increased. Therefore, the controller 30 can increase the temperature of the air flowing through the warm air chamber 50 and increase the rate of evaporation of the condensed water by reducing the opening degree of the valve of the decompressor 4 as the evaporation promoting control. Then, the controller 30 advances the process to step S50.

The process of step S50 is substantially the same as the process described in the first embodiment. In step S50, the controller 30 advances the process to step S62 after the predetermined period has elapsed.

In step S62, the controller 30 is configured to return the opening degree of the valve of the decompressor 4 to the original opening degree. Then, the controller 30 is configured to end the process for a moment and start the process from the step S10 again after a predetermined time has passed.

In the third embodiment described above, the controller 30 is configured to reduce the opening degree of the valve of the decompressor 4 as the evaporation promoting control. As a result, the third embodiment can also achieve the same advantages as those of the first embodiment.

### Fourth Embodiment

A fourth embodiment will be described. The fourth embodiment is also different from the first embodiment in a specific method of the evaporation promotion control executed by the controller 30. Other portions are the same as those of the first embodiment and only other portions different from those of the first embodiment will be described.

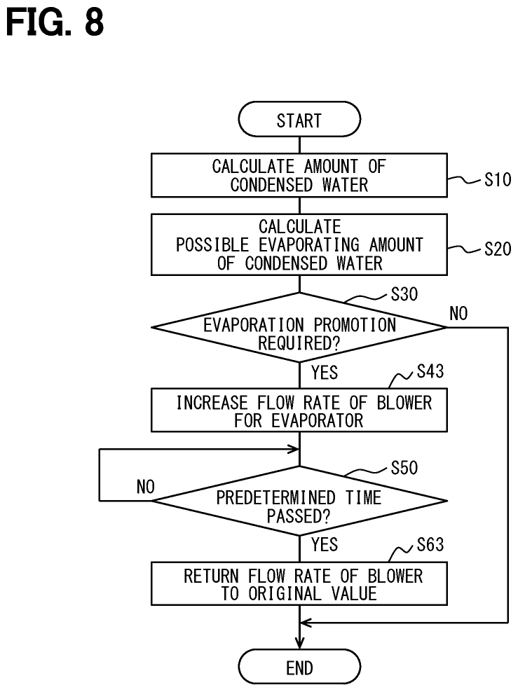

The process executed by the controller 30 of the fourth embodiment will be described with reference to the flowchart of FIG. 8.

The processes of steps S10 to S30 are the same as the processes described in the first embodiment.

When the controller 30 determines in step S30 that the evaporation promoting control for the condensed water stored in the air conditioner case 10 is required, the process is advanced to step S43.

In step S43, the controller 30 is configured to execute the evaporation promoting control for increasing the rate of evaporation of the condensed water. Specifically, in the fourth embodiment, the controller 30 is configured to increase a flow rate of the blower configured to provide an air to the evaporator 5 (hereinafter referred to as a blower for the evaporator 5) as the evaporation promoting control. That is, during the air-cooling, the controller 30 is configured to increase a flow rate of the blowing blower 7 that is the blower for the evaporator 5.

When the controller 30 increases the flow rate of the air passing through the evaporator 5, a cooling capacity of the air passing through the evaporator 5 is increased. As a result, the pressure of the low-pressure refrigerant is increased to meet the increase of the cooling capacity and a balance point is changed in a direction to increase the flow rate of the refrigerant. Further, when the flow rate of the refrigerant is increased, the amount of the heat of the refrigerant required to be released in the condenser 3 is increased. Thus, the pressure of the high-pressure refrigerant is increased corresponding to the temperature of the refrigerant. Thus, the temperature of the high-pressure refrigerant flowing through the condenser 3 is increased and the amount of air absorbed by the air passing through the condenser 3 from the high-pressure refrigerant flowing through the condenser 3 is increased.

As a result, the temperature of the warm air flowing through the warm air chamber 50 is increased. Therefore, the controller 30 can increase the rate of evaporation of the condensed water by increasing the flow rate of the blower for the evaporator 5 as the evaporation promoting control. Then, the controller 30 advances the process to step S50. The process of step S50 is substantially the same as the process described in the first embodiment. The controller 30 advances the process to step S63 when the controller 30 determines that the predetermined period has elapsed in step S50.

In step S63, the controller 30 returns the flow rate of the blower for the evaporator 5 to the original flow rate. Then, the controller 30 is configured to end the process for a moment and start the process from the step S10 again after a predetermined time has passed.

In the fourth embodiment described above, the controller 30 is configured to increase the flow rate of the blower for the evaporator 5 as the evaporation promoting control. As a result, the fourth embodiment can also achieve the same advantages as those of the first embodiment.

### Fifth Embodiment

A fifth embodiment will be described. The fifth embodiment is also different from the first embodiment in a specific method of the evaporation promotion control executed by the controller 30. Other portions are the same as those of the first embodiment and only other portions different from those of the first embodiment will be described.

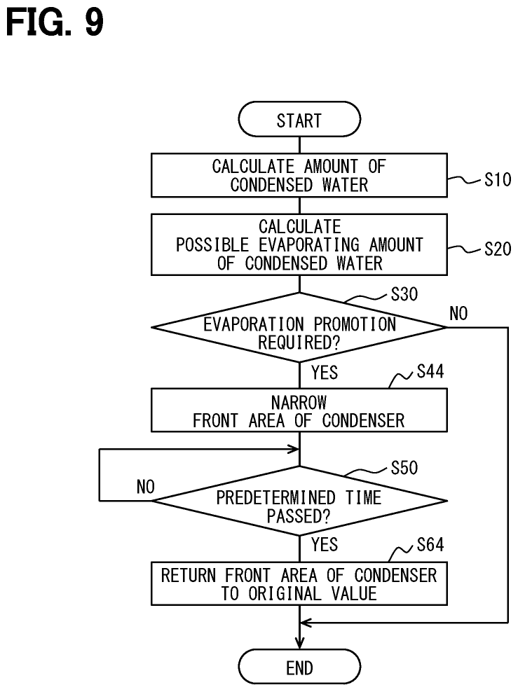

The process executed by the controller 30 of the fifth embodiment will be described with reference to the flowchart of FIG. 9.

The processes of steps S10 to S30 are the same as the processes described in the first embodiment.

When the controller 30 determines that the evaporation promotion control for the condensed water stored in the air conditioner case 10 is required, the process is advanced to step S44.

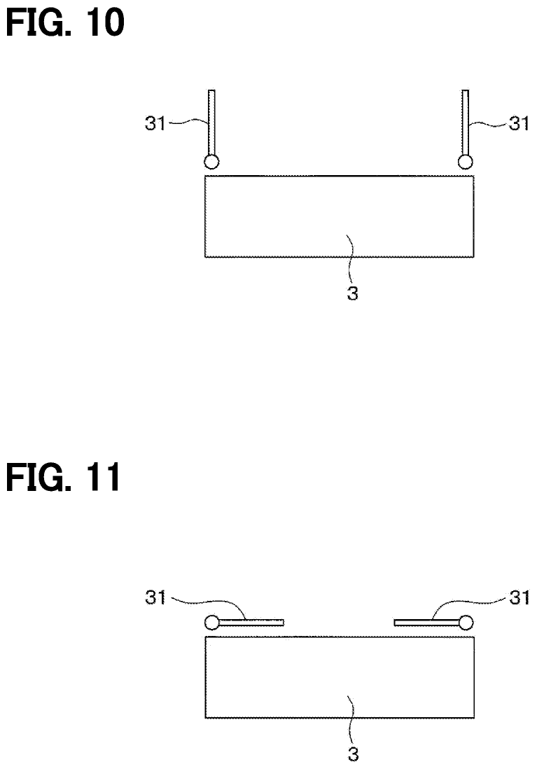

In step S44, the controller 30 executes the evaporation promotion control to increase the rate of evaporation of the condensed water. Specifically, in the fifth embodiment, the controller 30 is configured to narrow an area of a front surface of the condenser 3 to reduce an area of the condenser 3 that receives the air. As shown in FIG. 10, in the fifth embodiment, shutters 31 are disposed in front of the condenser 3. The shutters 31 are configured to open and close based on signals transmitted from the controller 30. The shape of the shutters 31 are not limited to the ones shown in the figure, and may be any shapes.

As shown in FIG. 11, when the shutters 31 in front of the condenser 3 are closed, an area of the front surface of the condenser 3 that receives the air is reduced and a flow rate of the air passing through the condenser 3 is reduced. Then, the heat dissipation capacity of the air passing through the condenser 3 is decreased and the pressure of the high-pressure refrigerant flowing through the condenser 3 is increased to balance the capacity of the refrigerant and the heat dissipation capacity of the air. Thus, the temperature of the high-pressure refrigerant flowing through the condenser 3 is increased. Therefore, the amount of heat of the high-pressure refrigerant flowing through the condenser 3 that is absorbed by the air flowing through the condenser 3 increases, so that the temperature of the warm air that passes through the condenser 3 and then flows through the warm air chamber 50 is increased. Therefore, the controller 30 can increase the rate of evaporation of the condensed water by narrowing the area of the front surface of the condenser 3 and increasing the temperature of the warm air flowing through the warm air chamber 50. Then, the controller 30 advances the process to step S50.

The process of step S50 is substantially the same as the process described in the first embodiment. The controller 30 advances the process to step S64 when the controller 30 determines that the predetermined period has elapsed in step S50.

In step S64, the controller 30 is configured to return the area of the front surface of the condenser 3 to the original area. Then, the controller 30 ends the process for a moment and starts the process from the step S10 again after a predetermined time has passed.

In the fifth embodiment described above, the controller 30 is configured to narrow the area of the front surface of the condenser 3. As a result, the fifth embodiment can also achieve the same advantages as those of the first embodiment.

### Sixth to Ninth Embodiments

The sixth to ninth embodiments are combinations of the above-mentioned first to third and fifth embodiments. When steps S40 and S44 described in the first and fifth embodiments described above are performed, the pressure of the high-pressure refrigerant increases, and the pressure of the low-pressure refrigerant also increases. On the other hand, when steps S41 and S42 described in the second and third embodiments described above are performed, the pressure of the high-pressure refrigerant increases and the pressure of the low-pressure refrigerant decreases.

Therefore, in the sixth to ninth embodiments, the controller 30 is configured to execute at least one of steps S40 or S44 described in the first embodiment and the fifth embodiment and at least one of steps S41 or S42 described in the second embodiment and the third embodiment as the evaporation promoting control. Specifically, the controller 30 is configured to execute at least one of a first control to decrease a flow rate of the blower for the condenser 3 or a second control to narrow an area of the front surface of the condenser 3, and to execute at least one of a third control to increase the rotational speed of the compressor 2 or a fourth control to reduce the opening degree of the valve of the decompressor 4 as the evaporation promoting control. As a result, a change in the low-pressure refrigerant is suppressed while the pressure of the high-pressure refrigerant is further increased. Therefore, the evaporation of the condensed water can be further assisted without changing the temperature and the flow rate of the air blown toward the passenger during the air-cooling, i.e., without affecting a comfort of the passenger. Hereinafter, the sixth to ninth embodiments will be described in detail.

### Sixth Embodiment

The sixth embodiment will be described. The sixth embodiment is a combination of the first embodiment and the second embodiment.

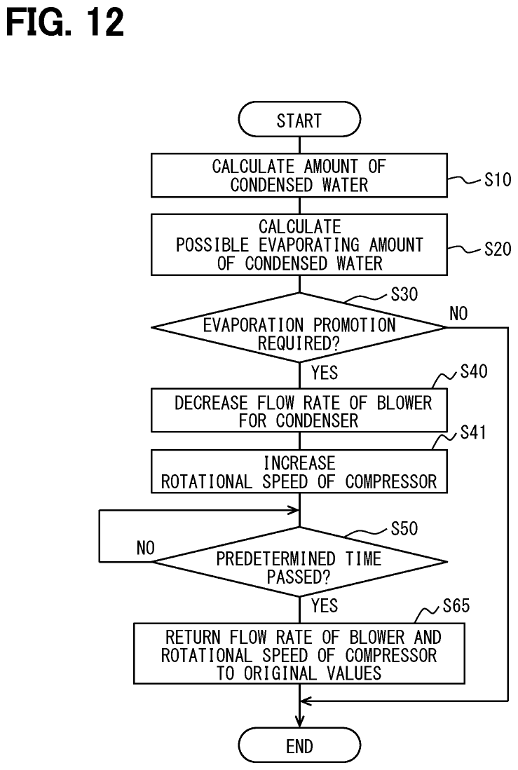

The process executed by the controller 30 of the sixth embodiment will be described with reference to the flowchart of FIG. 12.

The processes of steps S10 to S30 are the same as the processes described in the first embodiment.

When the controller 30 determines that the evaporation promotion control for the condensed water stored in the air conditioner case 10 is required, the process is advanced to step S40.

In step S40, the controller 30 decreases the flow rate of the blower for the condenser 3 as the evaporation promotion control. That is, during the air-cooling, the first control to decrease the flow rate of the exhaust blower 8 is performed.

In step S41, the controller 30 performs the third control to increase the rotational speed of the compressor 2.

As described above, when the first control to decrease the flow rate of the blower for the condenser 3 is performed, the pressure of the high-pressure refrigerant is increased and the pressure of the low-pressure refrigerant is also increased. On the other hand, when the third control to increase the rotational speed of the compressor 2 is performed, the pressure of the high-pressure refrigerant is increased and the pressure of the low-pressure refrigerant is decreased. Thus, in the sixth embodiment, the controller 30 is configured to decrease the flow rate of the blower for the condenser 3 and increase the rotational speed of the compressor 2 as the evaporation promoting control. As a result, a change in the low-pressure refrigerant is suppressed while the pressure of the high-pressure refrigerant is further increased. Therefore, the rate of evaporation of the condensed water is further increased without changing the temperature and the flow rate of the air blown toward the passenger during the air-cooling.

Then, the controller 30 advances the process to step S50. The process of step S50 is substantially the same as the process described in the first embodiment. The controller 30 advances the process to step S65 when the controller 30 determines in step S50 that the predetermined period has elapsed.

In step S65, the controller 30 returns the flow rate of the blower for the condenser 3 to the original flow rate and the rotational speed of the compressor 2 to the original speed. Then, the controller 30 ends the process for a moment and starts the process from the step S10 again after a predetermined time has passed.

In the sixth embodiment described above, the controller 30 is configured to decrease the flow rate of the blower for the condenser 3 and increase the rotational speed of the compressor 2 as the evaporation promoting control. Thereby, in the sixth embodiment, the pressure of the high-pressure refrigerant is further increased and the change in the pressure of the low-pressure refrigerant is suppressed. Therefore, the rate of evaporation of the condensed water is further increased without changing the temperature and the flow rate of the air blown toward the passenger during the air-cooling, i.e., without affecting a comfort of the passenger.

Further, in the sixth embodiment, since it is not necessary to use the electrically controlled expansion valve for the decompressor 4 and to dispose the shutters 31 for the condenser 3, a manufacturing cost can be reduced.

### Seventh Embodiment

The seventh embodiment will be described. The seventh embodiment is a combination of the first embodiment, the second embodiment, and the third embodiment.

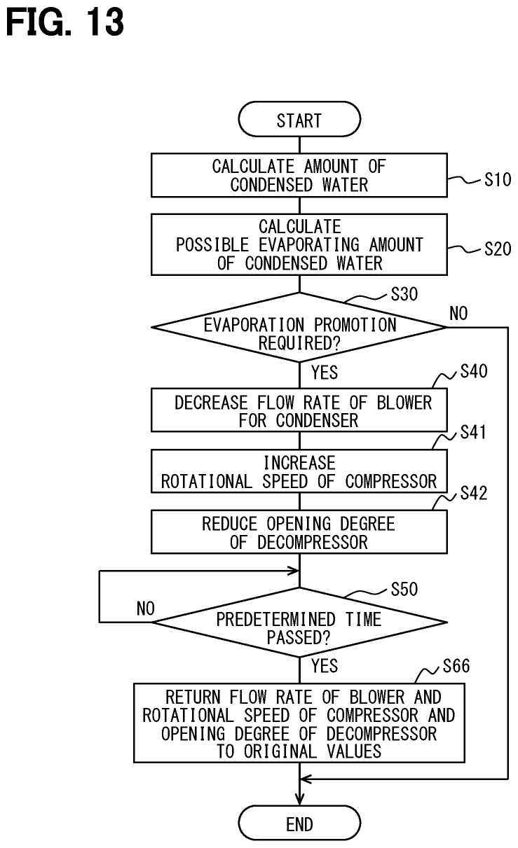

The process executed by the controller 30 of the seventh embodiment will be described with reference to the flowchart of FIG. 13.

The processes of steps S10 to S30 are the same as the processes described in the first embodiment.

When the controller 30 determines that the evaporation promotion for the condensed water stored in the air conditioner case 10 is required, the process is advanced to step S40.

In step S40, the controller 30 decreases the flow rate of the blower for the condenser 3 as the evaporation promotion control. That is, during the air-cooling, the flow rate of the exhaust blower 8 is decreased during the air-cooling.

In step S41, the controller 30 performs the third control to increase the rotational speed of the compressor 2 as the evaporation promotion control.

In step S42, the controller 30 reduces the opening degree of the valve of the decompressor 4 as the evaporation promoting control.

Then, the controller 30 advances the process to step S50. The process of step S50 is substantially the same as the process described in the first embodiment. The controller 30 advances the process to step S66 when the controller 30 determines in step S50 that the predetermined period has elapsed.

In step S66, the controller 30 returns the flow rate of the blower for the condenser 3 to the original flow rate, the rotational speed of the compressor 2 to the original speed, and the opening degree of the valve of the decompressor 4 to the original degree. Then, the controller 30 ends the process for a moment and starts the process from the step S10 again after a predetermined time has passed.

In the seventh embodiment described above, the controller 30 is configured to reduce the flow rate of the blower for the condenser 3, increase the rotational speed of the compressor 2, and reduce the opening degree of the valve of the decompressor 4 as the evaporation promoting control. As a result, in the seventh embodiment as well as in the sixth embodiment, it is possible to increase the pressure of the high-pressure refrigerant and suppress the change in the pressure of the low-pressure refrigerant. Therefore, the rate of evaporation of the condensed water is further increased without changing the temperature and the flow rate of the air blown toward the passenger during the air-cooling, i.e., without affecting a comfort of the passenger.

### Eighth Embodiment

The eighth embodiment will be described. The eighth embodiment is a combination of the first embodiment, the second embodiment, and the fifth embodiment.

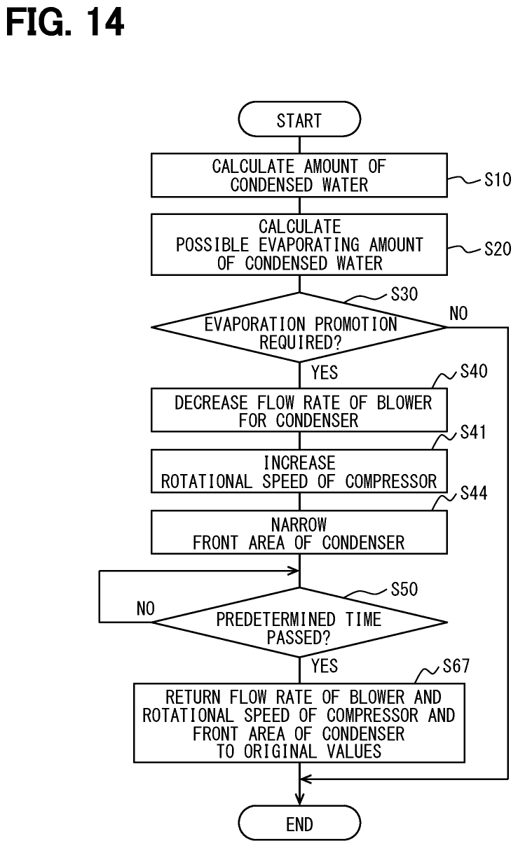

The process executed by the controller 30 of the eighth embodiment will be described with reference to the flowchart of FIG. 14.

The processes of steps S10 to S30 are the same as the processes described in the first embodiment.

When the controller 30 determines that the evaporation promotion control for the condensed water stored in the air conditioner case 10 is required, the process is advanced to step S40.

In step S40, the controller 30 decreases the flow rate of the blower for the condenser 3 as the evaporation promotion control. That is, during the air-cooling, the flow rate of the exhaust blower 8 is decreased.

In step S41, the controller 30 performs the third control to increase the rotational speed of the compressor 2 as the evaporation promotion control.

In step S44, the controller 30 narrows the area of the front surface of the condenser 3 as the evaporation promotion control.

Then, the controller 30 advances the process to step S50. The process of step S50 is substantially the same as the process described in the first embodiment. The controller 30 advances the process to step S67 when the controller 30 determines in step S50 that the predetermined period has elapsed.

In step S67, the controller 30 returns the flow rate of the air passing through the condenser 3 to the original flow rate, the rotational speed of the compressor 2 to the original speed, and the area of the front surface of the condenser 3 to the original area. Then, the controller 30 ends the process for a moment and starts the process from the step S10 again after a predetermined time has passed.

In the eighth embodiment described above, the controller 30 is configured to decrease the flow rate of the blower for the condenser 3, increase the rotational speed of the compressor 2, and narrow the area of the front surface of the condenser 3. As a result, in the eighth embodiment as well as in the sixth and seventh embodiments, it is possible to increase the pressure of the high-pressure refrigerant and suppress the change in the pressure of the low-pressure refrigerant. Therefore, the rate of evaporation of the condensed water is further increased without changing the temperature and the flow rate of the air blown toward the passenger during the air-cooling, i.e., without affecting a comfort of the passenger.

### Ninth Embodiment

The ninth embodiment will be described hereafter. The ninth embodiment is a combination of the second embodiment, the third embodiment, and the fifth embodiment.

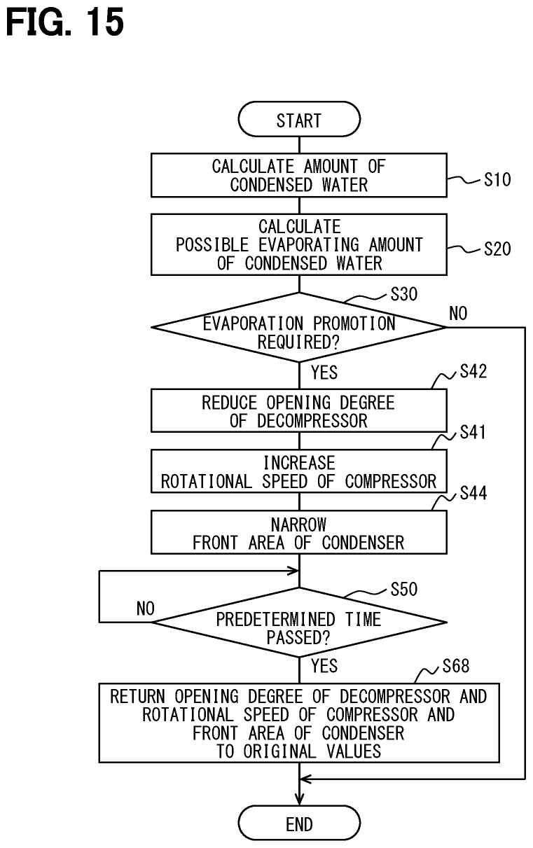

The process executed by the controller 30 of the ninth embodiment will be described with reference to the flowchart of FIG. 15.

The processes of steps S10 to S30 are the same as the processes described in the first embodiment.

When the controller 30 determines that the evaporation promotion control for the condensed water stored in the air conditioner case 10 is required, the process is advanced to step S42.

In step S42, the controller 30 reduces the opening degree of the decompressor 4 as the evaporation promoting control.

In step S41, the controller 30 increases the rotational speed of the compressor 2 as the evaporation promoting control.

In step S44, the controller 30 narrows the area of the front surface of the condenser 3 as the evaporation promoting control.

Then, the controller 30 advances the process to step S50. The process of step S50 is substantially the same as the process described in the first embodiment. The controller 30 advances the process to step S68 when the controller 30 determines in step S50 that the predetermined period has elapsed.

In step S68, the controller 30 returns the opening degree of the valve of the decompressor 4 to the original degree, the rotational speed of the compressor 2 to the original speed, and the area of the front surface of the condenser 3 to the original area. Then, the controller 30 ends the process for a moment and starts the process from the step S10 again after a predetermined time has passed.

In the ninth embodiment described above, the controller 30 is configured to reduce the opening degree of the decompressor 4, increase the rotational speed of the compressor 2, and narrow the area of the front surface of the condenser 3. As a result, in the ninth embodiment as well as in the sixth to eighth embodiments, it is possible to increase the pressure of the high-pressure refrigerant and suppress the change in the pressure of the low-pressure refrigerant. Therefore, the rate of evaporation of the condensed water is further increased without changing the temperature and the flow rate of the air blown toward the passenger during the air-cooling, i.e., without affecting a comfort of the passenger.

### Tenth Embodiment

The tenth embodiment will be described. The tenth embodiment is also different from the first embodiment in a specific method of the evaporation promotion control executed by the controller 30. Other portions are the same as those of the first embodiment and only other portions different from those of the first embodiment will be described.

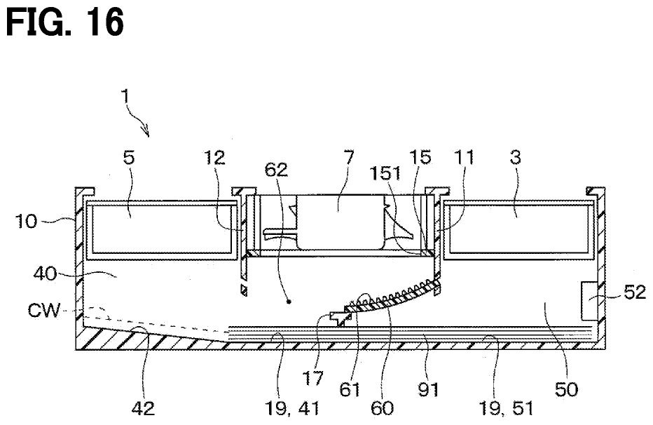

As shown in FIG. 16, a compact air conditioner of the tenth embodiment includes a heater 52 disposed in the warm air chamber 50 of the air conditioner case 10. An on/off operation of the heater 52 is controlled based on signals transmitted from the controller 30. The heater 52 is configured to heat the warm air flowing through the warm air chamber 50.

The process executed by the controller 30 of the tenth embodiment will be described with reference to the flowchart of FIG. 17.

The processes of steps S10 to S30 are the same as the processes described in the first embodiment.

When the controller 30 determines that the evaporation promoting control for the condensed water stored in the air conditioner case 10 is required, the process is advanced to step S45.

In step S45, the controller 30 is configured to increase the pressure of the high-pressure refrigerant by performing at least one of controls described in steps S40 to S44 as the evaporation promoting control. Thus, the temperature of the high-pressure refrigerant flowing through the condenser 3 is increased and the amount of heat of the high-pressure refrigerant flowing through the condenser 3 absorbed by the air passing through the condenser 3 is increased. As a result, the temperature of the warm air flowing through the warm air chamber 50 is increased.

In step S46, the controller 30 turns the heater 52 on as the evaporation promoting control. Thus, the warm air flowing through the warm air chamber 50 is heated by the heater 52 and the temperature of the warm air is further increased. Thus, the rate of evaporation of the condensed water is further increased.

Then, the controller 30 advances the process to step S50. The process of step S50 is substantially the same as the process described in the first embodiment. The controller 30 advances the process to step S69 when the controller 50 determines in step S50 that the predetermined period has elapsed.

In step S69, the controller 30 turns the heater 52 off and returns the pressure of the high-pressure refrigerant flowing through the refrigeration cycle to the original value. Then, the controller 30 ends the process for a moment and starts the process from the step S10 again after s predetermined time has passed.

In the tenth embodiment described above, the controller 30 is configured to increase the pressure of the high-pressure refrigerant of the refrigeration cycle and turn the heater 52 on as the evaporation promoting control. Thereby, in the tenth embodiment, it is possible to prevent the condensed water from leaking from the air conditioner case 10 by surely handling the condensed water in the air conditioner case 10.

The heater 52 described above may be configured to heat the warm air flowing through the warm air chamber 50 and directly heat the condensed water stored in the warm air chamber 50.

### Eleventh Embodiment

The eleventh embodiment will be described hereafter. In the eleventh embodiment, the configuration of the water directing unit is changed from that of the first embodiment. The other portions are similar to that in the first embodiment and only different portions from the first embodiment will be described.

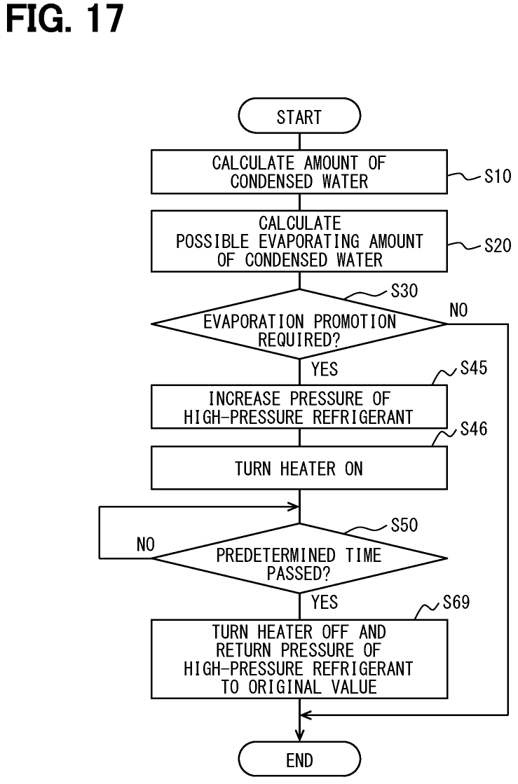

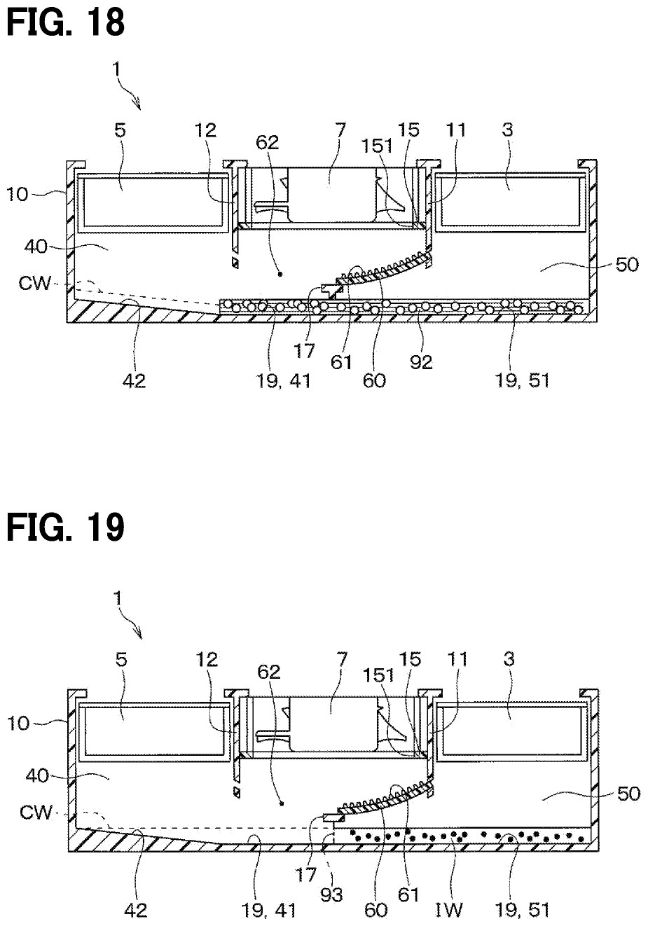

As shown in FIG. 18, in the eleventh embodiment, the water directing unit is configured by a porous member 92. The porous member 92 can be made of, for example, a porous metal, a porous ceramic, a sintered metal, or the like. The porous member 92 is provided from the bottom 41 of the cool air chamber 40 to the bottom 51 of the warm air chamber 50. The porous member 92 is configured to discharge the condensed water from the cool air chamber 40 to the warm air chamber 50 due to surface tension and capillary action. That is, the porous member 92 itself does not require a mechanical mechanism because it uses capillary force. Thus, the water directing unit can be downsized. Further, the porous member 92 is configured to prevent air from flowing between the cool air chamber 40 and the warm air chamber 50. The partition wall 17 for partitioning the cool air chamber 40 from the warm air chamber 50 is located on an upper side of the porous member 92.

In the eleventh embodiment as well as in the first embodiment, the porous member 92 has a first portion disposed on the bottom 41 of the cool air chamber 40 and a second portion disposed on the bottom 51 of the warm air chamber 50. The second portion has an area larger than that of the first portion. Further, in the eleventh embodiment as well as in the first embodiment, the tilted surface 42 is provided at the bottom 41 of the cool air chamber 40.

Thus, in the eleventh embodiment described above, the same advantages as those of the first embodiment can be obtained by applying the porous member 92 as the water directing unit.

### Twelfth Embodiment

The twelfth embodiment will be described. In the twelfth embodiment, the configuration of the water directing unit is changed from that of the first embodiment. The other portions are similar to those of the first embodiment and only different portions from the first embodiment will be described.

As shown in FIG. 19, in the twelfth embodiment, the water directing unit is configured by a semipermeable membrane 93 capable of allowing water molecules to permeate through the semipermeable membrane 93. The semipermeable membrane 93 is disposed between the bottom 19 of the air conditioner case 10 and the partition wall 17 at a boundary between the cool air chamber 40 and the warm air chamber 50. In the twelfth embodiment, an aqueous solution IW having an ion concentration higher than that of water is stored in the warm air chamber 50 so as to be in contact with the semipermeable membrane 93. Therefore, the semipermeable membrane 93 can direct the condensed water from the cool air chamber 40 to the warm air chamber 50 with osmotic pressure. Further, the semipermeable membrane 93 can prevent air from flowing between the cool air chamber 40 and the warm air chamber 50.

In the twelfth embodiment as well as in the first embodiment, the tilted surface 42 is disposed on the bottom 41 of the cool air chamber 40.

In the twelfth embodiment described above, the same advantages as those of the first embodiment can be obtained by using the semipermeable membrane 93 as the water directing unit.

### Thirteenth Embodiment

The thirteenth embodiment will be described. In the thirteenth embodiment, a configuration of the water directing unit and a control method for the water directing unit is changed from the first embodiment. Other portions are similar to those of the first embodiment and only other portions different from the first embodiment will be described.

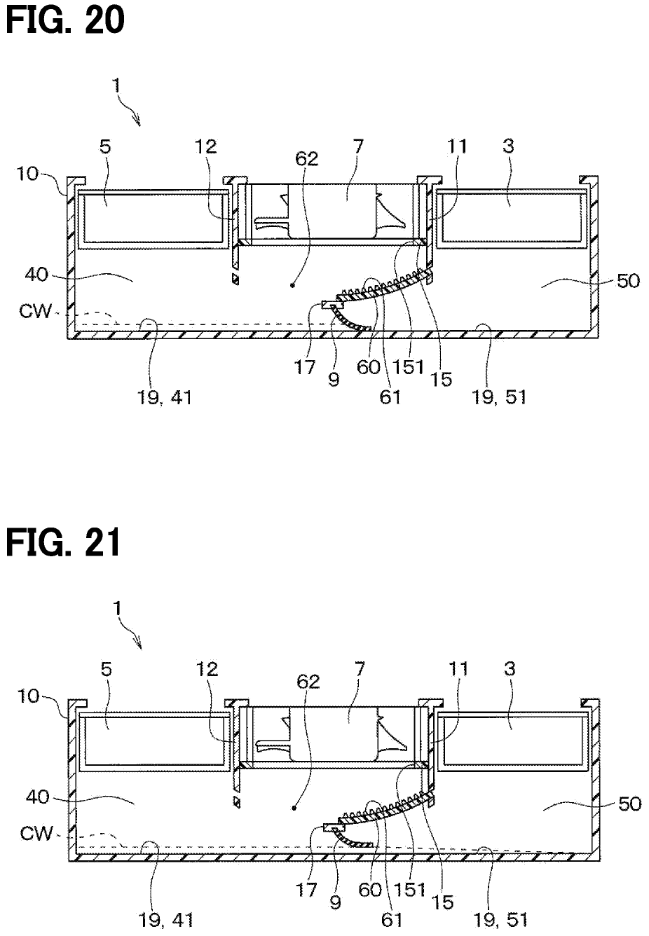

As shown in FIG. 20, in the thirteenth embodiment, the water directing unit is a differential pressure valve 9 disposed between the bottom 41 of the cool air chamber 40 and the bottom 51 of the warm air chamber 50. The differential pressure valve 9 is made of, for example, a rubber plate, a resin plate, or a metal plate, and is located between the partition wall 17 and the bottom 19 of the air conditioner case 10. The differential pressure valve 9 has an upper end fixed to and supported by the partition wall 17 and a lower end in contact with the bottom 19 of the air conditioner case 10. The differential pressure valve 9 is positioned such that the lower end of the differential pressure valve 9 faces toward the warm air chamber 50. In this state, the differential pressure valve 9 and the partition wall 17 partition off the space below the evaporator 5 from the space below the condenser 3. Then, as shown in FIG. 21, the lower end of the differential pressure valve 9 is configured to move upward away from the bottom 19 of the air conditioner case 10.

The differential pressure valve 9 is configured to open and close based on a differential pressure between the cool air chamber 40 and the warm air chamber 50. Specifically, the differential pressure valve 9 is configured to close when the pressure in the cool air chamber 40 is lower than the pressure in the warm air chamber 50. FIG. 20 shows a state where the differential pressure valve 9 is closed. In this state, the lower end of the differential pressure valve 9 that is opposite to the partition wall 17 is in contact with the bottom 19 of the air conditioner case 10. Therefore, when the differential pressure valve 9 is closed, air and water are prevented from flowing between the cool air chamber 40 and the warm air chamber 50.

On the other hand, the differential pressure valve 9 is configured to open when the pressure in the warm air chamber 50 is lower than the pressure in the cool air chamber 40. FIG. 21 shows a state where the differential pressure valve 9 is open. In this state, the lower end of the differential pressure valve 9 opposite to the partition wall 17 is located away from the bottom 19 of the air conditioner case 10.

The differential pressure valve 9 may be configured to open when the pressure of the warm air chamber 50 is lower than the pressure of the cool air chamber 40 and the differential pressure between the warm air chamber 50 and the cool air chamber 40 is greater than a predetermined value. The predetermined value is appropriately set by experiments.

The controller 30 is configured to close the differential pressure valve 9 by keeping the pressure of the cool air chamber 40 at a value lower than the pressure of the warm air chamber 50 during a normal operation. Then, the controller 30 is configured to decrease the pressure of the warm air chamber 50 to a value lower than the pressure of the cool air chamber 40 by increasing a flow rate of the air flowing through the warm air chamber 50 or decreasing a flow rate of the air flowing through the cool air chamber 40 when the condensed water in the cool air chamber 40 is greater than the predetermined amount. As a result, the differential pressure valve 9 is opened and the condensed water stored in the cool air chamber 40 is directed to the warm air chamber 50. That is, the differential pressure valve 9 serves as the water directing unit configured to direct the condensed water generated in the evaporator 5 from the cool air chamber 40 to the warm air chamber 50. The condensed water sent from the cool air chamber 40 to the warm air chamber 50 is evaporated in the warm air chamber 50 by the warm air having passed through the condenser 3. The water vapor evaporated from the condensed water is drawn into the exhaust blower 8 and discharged out of the vehicle cabin and the like through the exhaust blower duct (not shown) not to directly reach the passenger.

When the differential pressure valve 9 is configured to open when the pressure of the warm air chamber 50 is lower than the pressure of the cool air chamber 40 and a pressure difference between the warm air chamber 50 and the cool air chamber 40 is greater than a predetermined value, the controller 30 executes the following controls. That is, the controller 30 is configured to close the differential pressure valve 9 by keeping the pressure of the cool air chamber 40 at a value lower than the pressure of the warm air chamber 50 during the normal operation. Further, the controller 30 can keep the closing state of the differential pressure valve 9 by keeping the pressure difference between the cool air chamber 40 and the warm air chamber 50 within a specified range that is less than the predetermined value even if the pressure of the cool air chamber 40 is higher than the pressure of the warm air chamber 50. On the other hand, the controller 30 is configured to increase the flow rate of the air flowing through the warm air chamber 50 or decrease the flow rate of the air flowing through the cool air chamber 40 when the amount of the condensed water in the cool air chamber 40 is greater than the predetermined amount. By such control, the pressure of the warm air chamber 50 is made lower than the pressure of the cool air chamber 40 and the differential pressure between the warm air chamber 50 and the cool air chamber 40 is made greater than the predetermined value by the controller 30. As a result, the differential pressure valve 9 is opened and the condensed water stored in the cool air chamber 40 is directed to the warm air chamber 50.

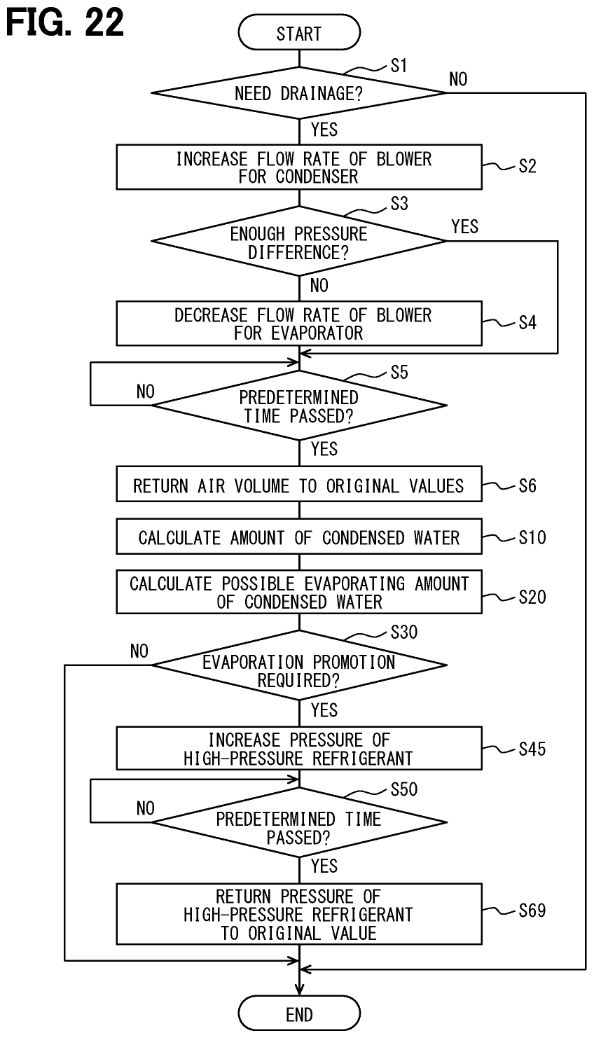

The process executed by the controller 30 of the thirteenth embodiment will be described with reference to the flowchart of FIG. 22. The process is performed for increasing the rate of evaporation of the condensed water in the warm air chamber 50 after or while the condensed water is directed into the warm air chamber 50. In this description, the compact air conditioner 1 performs the air-cooling in the vehicle cabin.

First, in step S1, the controller 30 determines whether it is required to discharge the condensed water stored in the cool air chamber 40 to the warm air chamber 50. This determination is made based on whether the amount of the condensed water in the cool air chamber 40 is greater than the predetermined amount. The predetermined amount is appropriately determined by experiments within a range in which the condensed water does not leak from the air conditioner case 10, a range in which electronic devices in the air conditioner case 10 are not exposed to the water, or a range in which the condensed water does not affect the conditioned air.

The amount of the condensed water stored in the cool air chamber 40 is calculated from, for example, the temperature, the humidity, and the flow rate of the air passing through the evaporator 5. Alternatively, when a water sensor is provided in the air conditioner case 10, the amount of the condensed water stored in the cool air chamber 40 may be detected based on signals output from the water sensor to the controller 30. This is the same as step S10 described in the first embodiment.

When the controller 30 determines that the condensed water stored in the cool air chamber 40 does not require to be discharged into the warm air chamber 50, the process is ended for a moment. Then, the controller 30 starts the process from step S1 again after a predetermined time has passed.

On the other hand, when the controller 30 determines that the condensed water stored in the cool air chamber 40 requires to be discharged into the warm air chamber 50, the process is advanced to step S2.

In step S2, the controller 30 increases the flow rate of the blower for the condenser 3. That is, the controller 30 increases the flow rate of the exhaust blower 8 during the air-cooling. Then, the controller 30 advances the process to step S3.

Next, in step S3, the controller 30 determines whether the differential pressure between the cool air chamber 40 and the warm air chamber 50 is enough to open the differential pressure valve 9. The differential pressure between the cool air chamber 40 and the warm air chamber 50 can be calculated from, for example, the flow rate of the blowing blower 7 and the flow rate of the exhaust blower 8. The memory of the controller 30 may store a map of relationships between the flow rate of the blowing blower 7, the flow rate of the exhaust blower 8, and differential pressure between the cool air chamber 40 and the warm air chamber 50. When the controller 30 determines in step S3 that the differential pressure between the cool air chamber 40 and the warm air chamber 50 is enough to open the differential pressure valve 9, the process is advanced to step S5.

On the other hand, when the controller 30 determines that the differential pressure between the cool air chamber 40 and the warm air chamber 50 is not enough to open the differential pressure valve 9 in step S3, the process is advanced to step S4.

In step S4, the controller 30 decreases the flow rate of the blower for the evaporator 5. That is, the controller 30 decreases the flow rate of the blowing blower 7 during the air-cooling. Then, the controller 30 advances the process to step S5.

In step S5, the controller 30 determines whether a predetermined period has elapsed after the differential pressure valve 9 was opened. The predetermined period is set to a period required for discharging the condensed water stored in the cool air chamber 40 to the warm air chamber 50. In step S5, the controller 30 proceeds the process to step S6 after the predetermined period has elapsed.

In step S6, the controller 30 returns the flow rate of the exhaust blower 8 and the flow rate of the blowing blower 7 to original flow rates. Then, the controller 30 advances the process to step S10.

The processes of steps S10 to S69 are the same as the processes described in the above-described first to tenth embodiments. Thus, descriptions thereof will be omitted.

In the thirteenth embodiment described above, the differential pressure valve 9 as the water directing unit is provided at the boundary between the cool air chamber 40 and the warm air chamber 50. As a result, the condensed water generated in the evaporator 5 is discharged from the cool air chamber 40 to the warm air chamber 50 by the differential pressure valve 9 and evaporated by the warm air flowing through the warm air chamber 50. The differential pressure valve 9 is provided at the boundary between the cool air chamber 40 and the warm air chamber 50, thereby reducing the space for providing the differential pressure valve 9 in the air conditioner case 10 and restricting the differential pressure valve 9 from interfering with other components in the air conditioner case 10. Therefore, the compact air conditioner 1 can improve a mountability in the vehicle without increasing the size of the compact air conditioner 1.

Further, in the thirteenth embodiment, the differential pressure valve 9 is configured to close when the pressure in the cool air chamber 40 is lower than the pressure in the warm air chamber 50, and open when the pressure in the warm air chamber 50 is lower than the pressure in the cool air chamber 40. As a result, the differential pressure valve 9 can be closed during the normal operation of the compact air conditioner 1, and the air and the water are prevented from flowing between the cool air chamber 40 and the warm air chamber 50. Then, the controller 30 is configured to open the differential pressure valve 9 if necessary, for example when the amount of the condensed water is greater than the predetermined amount, by increasing the flow rate of the air flowing through the warm air chamber 50 or decreasing the flow rate of the air flowing through the cool air chamber 40. Thus, the compact air conditioner 1 can discharge the condensed water from the cool air chamber 40 to the warm air chamber 50 on an as needed basis and prevent the air and the water from flowing between the cool air chamber 40 and the warm air chamber 50 during the normal operation.

The differential pressure valve 9 may be configured to open when the pressure of the warm air chamber 50 is lower than the pressure of the cool air chamber 40 and the differential pressure between the warm air chamber 50 and the cool air chamber 40 is greater than a predetermined value.

Further, in the thirteenth embodiment, the controller 30 is configured to increase the flow rate of the air flowing through the warm air chamber 50 or decrease the flow rate of the air flowing through the cool air chamber 40 when the condensed water is greater than the predetermined amount. As a result, the controller 30 can discharge the condensed water in the cool air chamber 40 to the warm air chamber 50 when the amount of the condensed water in the cool air chamber 40 is greater than the predetermined amount. Therefore, it is possible to restrict the condensed water from leaking from the air conditioner case 10.

### OTHER EMBODIMENTS

The present disclosure is not limited to the embodiments described above, and can be modified as appropriate. The above embodiments are not independent of each other, and can be appropriately combined except when the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Also, the shape, the positional relationship, and the like of the component or the like mentioned in the above embodiments are not limited to those being mentioned unless otherwise specified, limited to the specific shape, positional relationship, and the like in principle, or the like.

(1) In the thirteenth embodiment, the differential pressure valve 9 as the water directing unit is made of, for example, a rubber plate, but the present disclosure is not limited to this. The differential pressure valve 9 as the water directing unit may be, for example, a mechanical valve having a valve seat, a valve body, and a spring.

(2) In the above embodiments, the condenser 3 is disposed in the right portion of the air conditioner case 10 and the evaporator 5 is disposed in the left portion of the air conditioner case 10 when viewed from an upper side of the air conditioner case 10 as shown in FIG. 1. However, the present disclosure is not limited to this. That is, the condenser 3 may be arranged in the left portion and the evaporator 5 may be arranged in the right portion when viewed from the upper side of the air conditioner case 10. In that case, it is preferable that the compressor 2 have the inlet 21 on a right side of the compressor 2 closer to the evaporator 5 and the outlet 22 on a left side of the compressor 2 closer to the condenser 3.

(3) In the above embodiments, the blowing blower 7 is disposed around a center of the air conditioner case 10 and the exhaust blower 8 is disposed on a side of the blowing blower 7 opposite to the compressor 2. However, the present disclosure is not limited to this. That is, the exhaust blower 8 may be arranged around the center of the air conditioner case 10 and the blowing blower 7 may be arranged on a side of the exhaust blower 8 opposite to the compressor 2.

(4) In the above embodiment, the blowing blower 7 and the exhaust blower 8 are arranged at positions downstream of the condenser 3 and the evaporator 5 in the airflow direction. However, the present disclosure is not limited to this. The blowing blower 7 and the exhaust blower 8 may be arranged at positions upstream of the condenser 3 and the evaporator 5 in the airflow direction. Further, in that case, the blowing blower 7 and the exhaust blower 8 may be configured as a single blower. That is, the single blower may be configured to blow an air into the air-conditioning target space and exhaust an air.

The controller 30 and the method thereof described in the present disclosure may be implemented by a special purpose computer which is configured with a memory and a processor programmed to execute one or more particular functions embodied in computer programs of the memory. Alternatively, the controller 30 and the method described in the present disclosure may be implemented by a special purpose computer configured as a processor provided one or more hardware logic circuits. Alternatively, the controller 30 and the method described in the present disclosure may be implemented by one or more special purpose computer configured by a combination of (a) a memory and a processor programmed to execute one or more particular functions embodied in computer programs of the memory and (b) a processor provided by one or more hardware logic circuits. The computer readable program may be stored, as instructions to be executed by a computer, in a tangible non-transitory computer-readable medium.

(6) In the sixth to ninth embodiments, during the evaporation promoting control, the rate of evaporation of the condensed water is increased by suppressing the change in the pressure of the low-pressure refrigerant and increasing the pressure of the high-pressure refrigerant without changing the temperature and the flow rate of the air blown toward the passenger during the air-cooling.

The same advantages can be obtained by the following combinations.

(6-1) The controller 30 may combine the first control to decrease the flow rate of the air sent to the condenser 3 by the blower and the fourth control to reduce the opening degree of the valve of the decompressor 4 as the evaporation promoting control.

(6-2) The controller 30 may combine the second control to narrow the area of the front surface of the condenser 3 and the third control to increase the rotational speed of the compressor 2 as the evaporation promoting control.

(6-3) The controller 30 may combine the second control to narrow the area of the front surface of the condenser 3 and the fourth control to reduce the opening degree of the valve of the decompressor 4 as the evaporation promoting control.

(6-4) The controller 30 may combine the first control to reduce the flow rate of the air sent to the condenser 3 by the blower, the second control to narrow the area of the front surface of the condenser 3, and the fourth control to reduce the opening degree of the valve of the decompressor 4 as the evaporation promoting control.

(6-5) The controller 30 may combine the first control to decrease the flow rate of the air sent to the condenser 3 by the blower, the second control to narrow the area of the front surface of the condenser 3, the third control to increase the rotational speed of the condenser 3, and the fourth control to reduce the opening degree of the valve of the decompressor 4.

### Overview

According to the first aspect shown in a part or all of the above embodiments, a compact air conditioner includes a compressor, a condenser, a decompressor, an evaporator, a blower, an air conditioner case, and a controller. The compressor is configured to draw and discharge a refrigerant. The condenser is configured to condense the refrigerant discharged out of the compressor through heat exchange between the refrigerant and an air. The decompressor is configured to decompress and expand the refrigerant from the condenser. The evaporator is configured to evaporate the refrigerant from the decompressor through heat exchange between the refrigerant and an air. The refrigerant from the evaporator flows into the compressor. The blower is configured to provide an air to the condenser and the evaporator. The air conditioner case houses components of the refrigeration cycle including the compressor, the condenser, the decompressor, and the evaporator. The air conditioner case defines a cool air chamber therein through which a cool air having passed through the evaporator flows and a warm air chamber therein through which a warm air having passed through the condenser flows. The air conditioner case is configured to direct a condensed water generated in the evaporator toward the warm air chamber. The controller is configured to execute an evaporation promoting control to increase the rate of evaporation of the condensed water by increasing a temperature of the warm air flowing through the warm air chamber when an amount of the condensed water in the air conditioner case is greater than a predetermined amount.

According to the second aspect, the controller is configured to increase a pressure of a high-pressure refrigerant flowing out of the compressor to the decompressor through the condenser during the evaporation promoting control.

Thus, the temperature of the high-pressure refrigerant flowing through the condenser is increased by increasing the pressure of the high-pressure refrigerant flowing through the condenser. Therefore, the temperature of the warn air having passed through the condenser and flowing through the warm air chamber can be increased.

A method for increasing the pressure of the high-pressure refrigerant includes: (A) reducing the flow rate of the air sent to the condenser by the blower; (B) increasing the rotational speed of the compressor; (C) reducing the opening degree of the valve of the decompressor; (D) increasing the flow rate of the air sent to the evaporator by the blower; and (E) reducing the area of the front surface of the condenser.

When the controller executes at least one of the control to decrease the flow rate of the air sent to the condenser by the blower and the control to narrow the area of the front surface of the condenser, both the pressure of the high-pressure refrigerant and the pressure of the low-pressure reducing are increased. On the other hand, when the controller executes at least one of the control to increase the rotational speed of the compressor or the control to reduce the opening degree of the valve of the decompressor, the pressure of the high-pressure refrigerant is increased and the pressure of the low-pressure refrigerant is decreased.

Therefore, from the third aspect, the controller is configured to execute at least one of the first control to decrease the flow rate of the air sent to the condenser by the blower or the second control to narrow the area of the front surface of the condenser, and execute at least one of the third control to increase the rotational speed of the compressor or the fourth control to reduce the opening degree of the valve of the decompressor during the evaporation promoting control.

As a result, a change in the pressure of the low-pressure refrigerant is suppressed while the pressure of the high-pressure refrigerant is further increased. Therefore, the rate of evaporation of the condensed water is further increased without changing the temperature and the flow rate of the air blown toward the passenger during the air-cooling, i.e., without affecting a comfort of the passenger.

According to the fourth aspect, the controller is configured to decrease the flow rate of the air sent to the condenser by the blower and increase the rotational speed of the compressor during the evaporation promoting control.

According to this, the controller can achieve the same advantages as described in the third aspect with the minimum control.

According to the fifth aspect, the controller is configured to decrease the flow rate of the air sent to the condenser by the blower, to increase the rotational speed of the compressor, and reduce the opening degree of the valve of the decompressor.

According to this, the rate of evaporation of the condensed water is further increased by increasing the pressure of the high-pressure refrigerant without changing the temperature and the flow rate of the air blown toward the passenger during the air-cooling, i.e., without affecting a comfort of the passenger.

According to the sixth aspect, the controller is configured to decrease the flow rate of the air sent to the condenser by the blower, decrease the area of the front surface of the condenser, and increase the rotational speed of the compressor during the evaporation promoting control.

Even in this case, the similar advantages with those of the fifth aspect can be obtained.

According to the seventh aspect, the controller is configured to narrow the area of the front surface of the condenser, increase the rotational speed of the compressor, and reduce the opening degree of the decompressor during the evaporation promoting control.

Even in this case, the similar advantages with those of the fifth aspect can be obtained.

According to the eighth aspect, the compact air conditioner further includes a heater disposed in the warm air chamber. The controller is configured to increase a temperature of an air in the warm air chamber by energizing the heater during the evaporation promoting control.

Thus, the rate of evaporation of the condensed water is further increased by a heater control with the heater in addition to the evaporation promotion control.

What is claimed is:

1. A compact air conditioner comprising:
a compressor configured to draw and discharge a refrigerant;
a condenser configured to condense the refrigerant discharged out of the compressor through heat exchange between the refrigerant and an air;
a decompressor configured to decompress and expand the refrigerant from the condenser;
an evaporator configured to evaporate the refrigerant from the decompressor through heat exchange between the refrigerant and an air, the refrigerant from the evaporator flowing into the compressor;
a blower configured to provide an air to the condenser and the evaporator;
an air conditioner case housing the compressor, the condenser, the decompressor, and the evaporator, the air conditioner case defining a cool air chamber therein through which a cool air having flowed through the evaporator flows and a warm air chamber therein through which a warm air having flowed through the condenser flows, the air conditioner case being configured to direct a condensed water generated in the evaporator toward the warm air chamber; and
a controller configured to execute an evaporation promoting control to increase a rate of evaporation of the condensed water by increasing a temperature of an air in the warm air chamber when an amount of the condensed water in the air conditioner case is greater than a predetermined amount, wherein
during the evaporation promoting control, the controller is further configured to execute:
at least one of a first control to decrease a flow rate of an air sent to the condenser by the blower or a second control to narrow an area of a front surface of the condenser; and
at least one of a third control to increase a rotational speed of the compressor or a fourth control to reduce an opening degree of a valve of the decompressor.

2. The compact air conditioner according to claim 1, wherein
during the evaporation promoting control, the controller is further configured to:
decrease the flow rate of the air sent to the condenser by the blower; and
increase the rotational speed of the compressor.

3. The compact air conditioner according to claim 1, wherein
during the evaporation promoting control, the controller is further configured to:
decrease the flow rate of the air sent to the condenser by the blower;
increase the rotational speed of the compressor; and
reduce the opening degree of the valve of the decompressor.

4. The compact air conditioner according to claim 1, wherein
during the evaporation promoting control, the controller is further configured to:
decrease the flow rate of the air sent to the condenser by the blower;
narrow the area of the front surface of the condenser; and
increase the rotational speed of the compressor.

5. The compact air conditioner according to claim 1, wherein
during the evaporation promoting control, the controller is further configured to:
narrow the area of the front surface of the condenser;
increase the rotational speed of the compressor; and
reduce the opening degree of the valve of the decompressor.

6. The compact air conditioner according to claim 1, further comprising
a heater disposed in the warm air chamber, wherein
during the evaporation promoting control, the controller is further configured to increase the temperature of the air in the warm air chamber by energizing the heater.

7. A controller for an air conditioner including:
a compressor configured to draw and discharge a refrigerant;
a condenser configured to condense the high-pressure refrigerant from the compressor through heat exchange between the high-pressure refrigerant and an air;
a decompressor configured to decompress the high-pressure refrigerant from the condenser;
an evaporator configured to evaporate the low-pressure refrigerant from the decompressor through heat exchange between the low-pressure refrigerant and an air; and
a warm air chamber through which a warm air from the condenser flows, wherein
a condensed water is generated in the evaporator and guided to the warm air chamber, the controller comprising:
one or more processors; and
a memory coupled to the one or more processors and storing instructions that, when executed by the one or more processors, cause the one or more processors to at least:
determine whether an amount of the condensed water is greater than a predetermined amount; and
increase a temperature of the warm air in the warm air chamber upon determining that the amount of the condensed water is greater than the predetermined amount by executing (i) at least one of a first control to decrease a flow rate of an air sent to the condenser by the blower or a second control to narrow an area of a front surface of the condenser, and (ii) at least one of a third control to increase a rotational speed of the compressor or a fourth control to reduce an opening degree of a valve of the decompressor.

8. A method for an air conditioner including:
a compressor configured to draw and discharge a refrigerant;
a condenser configured to condense the high-pressure refrigerant from the compressor through heat exchange between the high-pressure refrigerant and an air;
a decompressor configured to decompress the high-pressure refrigerant from the condenser;
an evaporator configured to evaporate the low-pressure refrigerant from the decompressor through heat exchange between the low-pressure refrigerant and an air; and
a warm air chamber through which a warm air from the condenser flows, wherein
a condensed water is generated in the evaporator and is guided to the warm air chamber, the method implemented by one or more processors, comprising:
determining whether an amount of the condensed water is greater than a predetermined amount; and
increasing a temperature of the warm air upon determining that the amount of the condensed water is greater than the predetermined amount by executing (i) at least one of a first control to decrease a flow rate of an air sent to the condenser by the blower or a second control to narrow an area of a front surface of the condenser, and (ii) at least one of a third control to increase a rotational speed of the compressor or a fourth control to reduce an opening degree of a valve of the decompressor.
